(19) United States
(12) Patent Application Publication
(10) Pub. No.: US 2026/0301076 A1
(43) Pub. Date: Oct. 1, 2026

(54) RUNTIME-RECONFIGURABLE TRANSACTION PROCESSING ARCHITECTURE WITH DATA-STORE-RESIDENT CONFIGURATION OBJECTS, PRODUCT-SCOPED PROCESSOR RESOLUTION, AND DUAL-MODE EXECUTION FOR CONFIGURABLE FINANCIAL PRODUCT LIFECYCLE MANAGEMENT

(71) Applicant: Manish Choudhary, Boston, MA (US)

(72) Inventor: Manish Choudhary, Boston, MA (US)

(21) Appl. No.: 19/630,960

(22) Filed: Mar. 27, 2026

Related U.S. Application Data
(60) Provisional application No. 63/778,885, filed on Mar. 27, 2025.

(51) Int. Cl. G06Q 40/08; G06Q 10/0633

(52) U.S. Cl. CPC G06Q 40/08; G06Q 10/0633

(57) ABSTRACT

A system and method for dynamically constructing and executing computational pipelines from data-store-resident configuration objects to process state transitions of financial agreement records. The system stores state configuration objects, transaction type configuration objects, and state transition configuration objects in one or more data stores. Upon receiving a transaction request, a processing engine identifies matching configuration objects, resolves serialized processing directive sequences from multiple independent configuration sources, and executes the resolved processor implementations through a three-phase pipeline comprising validation, calculation, and commitment phases. A product-scoped processor registry resolves processing directives to product-specific or generic processor implementations using a two-tier resolution mechanism. The system supports a dual-mode execution architecture in which a preview mode executes the validation and calculation phases without the commitment phase, enabling non-destructive projections using identical production processor implementations. The architecture supports configurable financial product lifecycle management across multiple product families including annuity, life insurance, and health insurance products.

This application claims the benefit of U.S. Provisional Patent Application No. 63/778,885, filed Mar. 27, 2025, entitled “AI-Orchestrated Multi-Tenant Asset Liability Management and Hedging Optimization Platform for Insurance Pricing and Risk Control,” the entire disclosure of which is incorporated herein by reference. Certain claims in this application contain subject matter not disclosed in the provisional application and are entitled to a filing date of this non-provisional application.

### FIELD OF THE INVENTION

The present invention relates generally to computer architectures for runtime-reconfigurable transaction processing using data-store-resident configuration objects containing serialized processing directives. More particularly, the invention relates to a dual-layer configuration architecture in which two independent configuration object types each define processing directive sequences that are merged at runtime to dynamically construct computational pipelines without application code modification. The invention further relates to product-scoped processor registries that resolve processing directives to specific implementations through two-tier resolution with generic fallback, enabling calculation component reuse across product types. The invention additionally relates to dual-mode execution architectures supporting both non-destructive preview and persistent commitment of financial agreement state transitions, and to valuation systems that reuse production transaction processors in preview mode for regulatory liability projection. The invention further relates to distributed computational agent systems coordinated through standardized protocols for generating portfolio optimization outputs with closed-loop feedback to versioned rate publication pipelines.

### BACKGROUND OF THE INVENTION

Traditional policy administration systems for insurance products encode agreement lifecycle rules directly in application logic. State transitions, processing sequences, version management rules, and transaction validation logic are implemented as compiled code within the application. Each new insurance product variation, regulatory change, or business rule modification requires engineering effort to modify the application code, followed by testing, quality assurance, and redeployment cycles. This creates rigid systems that cannot adapt to new products or market conditions without significant development investment and operational risk.

Furthermore, the processing logic applied during agreement state transitions is typically tightly coupled to the application architecture. When a policy transitions from one state to another, the calculations performed, the validations applied, and the post-processing actions taken are determined by branching logic embedded in the application code. Adding new calculation types, modifying processing sequences, or introducing product-specific calculation variants requires modifying the core transaction processing engine, which increases complexity and regression risk.

In addition, insurance products vary significantly in their lifecycle requirements. An annuity product may require different states, transitions, and processing sequences than a term life product or an indexed universal life product. Traditional systems address this variation through conditional logic within a monolithic processing engine, resulting in increasingly complex and fragile codebases as the number of supported products grows.

A further limitation of conventional policy administration systems is their restriction to a single product line. Life insurance, annuities, and health insurance evolved under different regulatory frameworks, different tax treatments, and different filing requirements, leading most platform vendors to hardcode product-line-specific assumptions into the data model and calculation engine. An annuity system assumes accumulation values, crediting strategies, and market value adjustments as first-class concepts; a life system assumes mortality tables, cost-of-insurance charges, and cash value calculations; a long-term care system assumes benefit pools and elimination periods. When these assumptions are embedded in the database schema and compiled code rather than externalized into configuration objects, the platform cannot administer products across multiple lines of business without maintaining entirely separate systems. This forces insurance carriers to operate independent administration platforms for each product line, creating data silos that prevent unified policyholder views, consolidated reporting, and cross-product servicing.

The calculation engine problem compounds the multi-product-line limitation. Each product line employs fundamentally different mathematical models: interest crediting and market value adjustment for annuities, net amount at risk and cost of insurance for life products, benefit exhaustion and cost-of-living adjustment for health products. Conventional platforms build monolithic calculation engines tightly coupled to one product family, making it impractical to reuse calculation components across product lines. For example, an indexed universal life product could in principle reuse the same indexed crediting calculation engine as a fixed indexed annuity and simply layer cost-of-insurance charges on top, but this reuse is impossible when the crediting engine is hardcoded to an annuity-specific data model. The absence of a product-agnostic calculation framework that can compose and sequence calculation processors across product lines represents a significant architectural limitation in existing platforms.

A structural problem in the insurance industry is the model-to-administration reconciliation burden. Every carrier that computes regulatory reserves typically must maintain two independent implementations of every product calculation: one in the policy administration system for real transactions, and one in the actuarial projection system (such as Prophet, AXIS, MoSes, or Polysystems) for reserve projections. These two codebases are written by different teams, often different vendors, years apart, using different programming languages and different mathematical libraries. Every quarter, the actuarial team must run a model-to-admin reconciliation that attempts to prove that the actuarial system's projection of a policy's account value matches what the administration system actually computed. These reconciliations routinely surface discrepancies (different rounding conventions, different interpolation methods, different edge case handling for mid-term withdrawals or partial surrenders), and resolving them consumes weeks of actuarial staff time per quarter. The root cause is architectural: the actuarial system cannot use the administration system's calculation logic, and the administration system cannot run hypothetical projections.

Separately, asset-liability management (ALM), hedging, and product pricing functions in insurance organizations have historically operated as independent, siloed systems. ALM systems project liabilities and assess risk exposure. Hedging systems construct derivative portfolios to mitigate identified risks. Pricing systems set product rates based on actuarial assumptions and competitive positioning. The disconnect between these systems means that hedging costs and effectiveness are not systematically fed back into pricing decisions, resulting in suboptimal capital efficiency and delayed response to changing market conditions.

Prior approaches to integrating these functions have relied on manual processes, periodic batch data transfers, or custom point-to-point integrations that are expensive to maintain and slow to adapt. The lack of a unified platform that combines configurable policy administration with AI-orchestrated ALM and hedging optimization represents a significant technical gap in the insurance technology landscape.

### SUMMARY OF THE INVENTION

The present invention addresses the foregoing technical limitations through a configurable insurance agreement lifecycle management platform that decouples processing logic from application code by storing state definitions, transition rules, and processing directive sequences as serialized data in one or more data stores. At transaction time, the platform retrieves the applicable configuration objects and dynamically constructs a processing pipeline tailored to the specific agreement, product, current state, and transaction type. This architecture enables runtime reconfiguration of agreement lifecycle behavior without modifying or redeploying application code.

In one aspect, the invention provides a method for managing insurance agreement state transitions comprising: storing, in one or more data stores, state configuration objects, transition configuration objects, and transaction type configuration objects, wherein each transition configuration object and each transaction type configuration object independently contain serialized processing directive sequences; receiving a transaction request; resolving the applicable configuration objects based on the agreement's current state and the transaction type; merging the processing directive sequences from both configuration object layers; executing the merged directives against agreement data; and transitioning the agreement to a target state. The transaction type configuration objects further specify a version impact indicator that determines whether the transaction creates no new version, a minor version, or a major version of the agreement record.

In another aspect, the invention provides a product-scoped processor registry that maintains a collection of processor implementations, each identified by a processor name and optionally scoped to a specific product type. When processing directives reference a processor by name, the registry resolves the appropriate implementation by first searching for a product-scoped match and, if none is found, selecting a generic fallback implementation. Processors execute in a defined order, with each processor's results accumulated into a shared context accessible to subsequent processors in the chain. This architecture enables calculation components to be reused across product lines: for example, an indexed crediting processor may serve both indexed annuity and indexed universal life products, with product-specific processors layered on top through the ordered execution sequence.

In yet another aspect, the invention provides a method for transforming standardized insurance data interchange documents into lifecycle-governing configuration objects. The method auto-detects the product type from the interchange document content and applies product-type-specific mapping rules to generate product configuration objects and lifecycle flow configuration objects that govern subsequent state transition processing for agreements of the corresponding product type.

In a further aspect, the invention provides a valuation subsystem that eliminates the model-to-administration reconciliation problem by projecting regulatory reserve cash flows through the same product-scoped processor registry used for production transactions. The valuation subsystem executes transaction calculations in a preview mode that returns calculated financial impacts without persisting state changes, scaled to production valuation workloads across thousands of policies, thousands of economic scenarios, and hundreds of projection time steps. Because this dual use of the processor registry invokes the same processor instances for both real transactions and hypothetical projections, the resulting projection calculations correspond to production calculations by virtue of execution through the same processor resolution and execution pathway under equivalent inputs, obviating the need for a separately maintained actuarial projection model and the associated quarterly reconciliation burden. The valuation subsystem further provides hierarchical assumption governance, economic scenario storage, segment projection under economic scenarios, and structured data exports to external actuarial systems for carriers that maintain their existing actuarial platforms.

In yet a further aspect, the invention provides an AI-orchestrated platform for integrated asset-liability management and hedging optimization that utilizes the configurable lifecycle management system. The platform employs a plurality of specialized computational agents coordinated through an orchestration engine for data collection, scenario modeling, hedge strategy formulation, and dynamic pricing. A hedge-to-rate feedback mechanism transmits pricing adjustments through a rate publication pipeline with versioned rate levels, enabling closed-loop integration between hedging decisions and product pricing within the configurable lifecycle management platform. Human-in-the-loop governance interfaces enforce manual approvals at configurable decision points.

The platform supports multi-tenant deployment with database-per-tenant isolation, dynamic connection pool routing, and tenant-specific configuration, enabling multiple insurance organizations to operate independently within a shared infrastructure while maintaining regulatory-compliant data segregation.

### BRIEF DESCRIPTION OF THE DRAWINGS

FIG. 1 is a block diagram illustrating the agreement lifecycle state machine configuration architecture, showing the relationships between state configuration objects, transition configuration objects, transaction type configuration objects, and lifecycle flow configuration objects stored in a data store.

FIG. 2 is a flowchart illustrating the three-phase transaction processing engine with dual-mode execution, showing the validation phase, calculation phase, and commitment phase, with a configurable halt point for preview mode.

FIG. 3 is a block diagram illustrating the product-scoped processor registry resolution flow, showing how a processing directive identifier is resolved to a specific processor implementation through product-scoped matching with generic fallback.

FIG. 4 is a flowchart illustrating the standardized data interchange pipeline, showing the transformation of an interchange document into lifecycle-governing configuration objects through auto-detection and product-type-specific mapping.

FIG. 5 is a system architecture diagram illustrating the integrated platform, showing the relationship between the configurable lifecycle engine, the processor architecture, the data interchange pipeline, the rate publication pipeline, the valuation subsystem, and the AI-orchestrated ALM and hedging system.

FIG. 6 is a block diagram illustrating the AI agent orchestration system, comprising a hierarchical arrangement of specialized computational agents coordinated through a central orchestration layer.

FIG. 7 is a sequence diagram illustrating agent collaboration patterns for hedge strategy optimization, strategy execution and monitoring, and assumption update workflows.

FIG. 8 is a block diagram illustrating the internal architecture of the hedge optimization agent, comprising input processing, core processing engine, state management, output generation, and external integration layers.

FIG. 9 is a block diagram illustrating the policyholder behavior model structure, including lapse, withdrawal, and annuitization models responsive to economic factor sensitivity.

FIG. 10 is a block diagram illustrating the hedge-to-rate feedback integration with human-in-the-loop controls and the rate publication pipeline connecting the AI-orchestrated platform to the configurable lifecycle management system.

FIG. 11 is a flowchart illustrating the simulation sandbox and explainability workflow, showing how the dual-mode transaction processing engine supports what-if analysis and how the explanation engine generates role-specific narratives.

FIG. 12 is a block diagram illustrating the valuation subsystem architecture, showing the two-tier structure comprising Tier 1 (valuation-ready policy administration) with scenario store, hierarchical assumption governance, projection orchestrator, segment projection, actuarial system export, and cash flow storage; and Tier 2 (native reserve computation) with results aggregator, deterministic reserve calculator, and valuation run manager.

### DETAILED DESCRIPTION OF THE INVENTION

### 1. Configurable Agreement Lifecycle Management System

The following detailed description sets forth specific embodiments of the invention. These embodiments are illustrative and not limiting. The invention may be practiced in various forms and configurations beyond those specifically described herein.

### 1.1 Technical Problem and Solution Overview

In conventional policy administration systems, the rules governing agreement lifecycle management are encoded directly in application source code. For example, when an insurance agreement transitions from an application state to an underwriting state, the calculations to perform, the validations to apply, and the post-processing actions to execute are determined by conditional branching logic (such as if-then-else statements or switch-case constructs) compiled into the application binary. This approach presents several technical limitations.

First, adding support for a new insurance product type or modifying the lifecycle behavior of an existing product requires modifying application source code, recompiling, testing, and redeploying the application. This process typically requires days to weeks of engineering effort and introduces regression risk to the production system. Second, the conditional branching logic grows in complexity proportional to the number of supported products, creating a fragile codebase where modifications to one product's lifecycle logic may inadvertently affect other products. Third, the processing sequences applied during state transitions cannot be reconfigured at runtime, meaning that operational adjustments (such as adding a new validation step or changing the order of calculations) require a full development and deployment cycle.

The present invention addresses these limitations by externalizing lifecycle management rules into configuration objects stored in one or more data stores. Rather than encoding state transitions, processing sequences, and version management rules in application code, these rules are represented as serialized data structures that the processing engine retrieves and interprets at runtime. This architecture enables the platform to reconfigure agreement lifecycle behavior by modifying data store records rather than application code, without requiring code changes, recompilation, or redeployment when product lifecycle requirements change.

### 1.2 Agreement State Configuration Objects

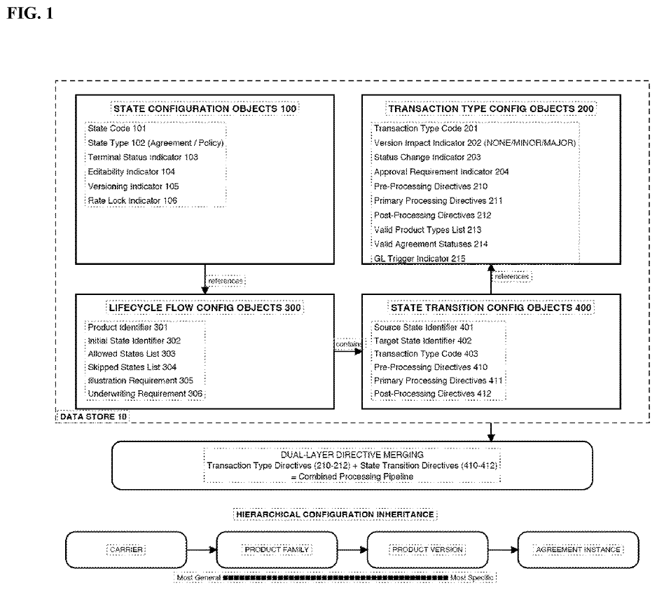

Referring now to FIG. 1, the configurable lifecycle management system stores a plurality of state configuration objects 100 in a data store 10. Each state configuration object 100 defines a permissible state for insurance agreements and comprises the following properties: a state code 101 uniquely identifying the state; a state type 102 classifying the state as an agreement-level state or a policy-level state; a terminal status indicator 103 specifying whether the state is a terminal state from which no further transitions are permitted; an editability indicator 104 specifying whether agreement data may be modified while the agreement is in this state; a versioning indicator 105 specifying whether new versions of the agreement record may be created while in this state; and a rate lock indicator 106 specifying whether rate parameters are locked against modification while in this state.

In a preferred embodiment, the system stores fourteen state configuration objects representing the following agreement states: DRAFT, PENDING_REVIEW, APPROVED, BOUND, PENDING_ISSUE, IN_FORCE, PAID_UP, REDUCED_PAID_UP, EXTENDED_TERM, IN_CLAIM, SURRENDERED, LAPSED, MATURED, and CANCELLED. Of these, SURRENDERED, LAPSED, MATURED, and CANCELLED are configured as terminal states (terminal status indicator set to true), meaning that agreements in these states cannot transition to any other state. States such as IN_FORCE, PAID_UP, and IN_CLAIM have their rate lock indicators set to true, preventing rate modifications to active agreements. States such as DRAFT, PENDING_REVIEW, and APPROVED have their editability indicators set to true, permitting data modifications during the pre-issue lifecycle phases.

The state configuration objects are not limited to the specific states described above. Alternative embodiments may define different state sets, additional states, or fewer states as appropriate for particular insurance product types or regulatory environments. The state configuration objects may be stored in relational database tables, document databases, key-value stores, file-based configuration systems, or any other persistent data store capable of storing structured data.

### 1.3 Transaction Type Configuration Objects

Still referring to FIG. 1, the system further stores a plurality of transaction type configuration objects 200 in the data store 10. Each transaction type configuration object 200 defines a type of transaction that may be applied to an insurance agreement and comprises: a transaction type code 201 uniquely identifying the transaction type; a version impact indicator 202 specifying whether the transaction creates no new version (NONE), a minor version (MINOR), or a major version (MAJOR) of the agreement record; a status change indicator 203 specifying whether the transaction changes the agreement's state; an approval requirement indicator 204 specifying whether human approval is required before the transaction may be committed; and one or more serialized processing directive sequences.

The serialized processing directive sequences within each transaction type configuration object 200 comprise three ordered lists: a pre-processing directive sequence 210, a primary processing directive sequence 211, and a post-processing directive sequence 212. Each directive in these sequences is a reference identifier (such as a string name) that maps to a registered processor implementation in the platform's processor registry. For example, a transaction type configuration object for a “WITHDRAWAL” transaction might specify a primary processing directive sequence of [“SURRENDER_CHARGE”, “MVA_ADJUSTMENT”, “WITHDRAWAL_CALC”, “GLWB_WITHDRAWAL”], indicating that upon execution, the platform should invoke these four processors in order.

In a preferred embodiment, the system stores twenty-eight transaction type configuration objects representing transactions including: NEW_APPLICATION, UNDERWRITE, APPROVE, BIND, ISSUE, PREMIUM_PAYMENT, WITHDRAWAL, FULL_SURRENDER, DEATH_CLAIM, RATE_CHANGE, ENDORSEMENT, FREE_LOOK_CANCEL, REINSTATE, LAPSE, MATURITY, EXTEND_TERM, REDUCE_PAID_UP, ANNUITIZE, TRANSFER, LOAN, REPAYMENT, INTEREST_CREDIT, ANNIVERSARY_PROCESS, STATEMENT_GENERATE, FEE_ASSESS, RIDER_ADD, RIDER_REMOVE, CANCEL, and VALUATION_PROJECTION. The VALUATION_PROJECTION transaction type is configured as preview-only (its configuration permanently prevents Phase 3 commitment), enabling the same processor pipeline used for real transactions to execute hypothetical projections for regulatory valuation without risk of persisting state changes.

The transaction type configuration objects further comprise: a list of valid product types 213 specifying which insurance products this transaction type applies to, serialized as structured data; a list of valid agreement statuses 214 specifying in which agreement states this transaction type may be executed; and a general ledger trigger indicator 215 specifying whether the transaction generates accounting entries. These properties enable the platform to validate transaction requests against the current agreement context before executing the processing pipeline.

### 1.4 Product-Specific Lifecycle Flow Configuration Objects

The system further stores lifecycle flow configuration objects 300 in the data store 10, each associated with a specific product identifier 301. Each lifecycle flow configuration object 300 defines the specific lifecycle behavior for agreements of a particular product type and comprises: an initial state identifier 302 specifying the state assigned to newly created agreements of this product; an allowed states list 303 serialized as structured data, defining which states from the plurality of state configuration objects are available for this product; a skipped states list 304 serialized as structured data, defining which states are bypassed in this product's lifecycle (enabling abbreviated lifecycle flows for simpler products); and optional product-specific flags such as an illustration requirement indicator 305 and an underwriting requirement indicator 306.

Each lifecycle flow configuration object 300 is associated with a plurality of state transition configuration objects 400 that define the valid transitions within that product's lifecycle. Each state transition configuration object 400 comprises: a source state identifier 401 specifying the state from which the transition originates; a target state identifier 402 specifying the state to which the transition leads; a transaction type code 403 specifying which transaction type triggers this transition; and its own independent set of serialized processing directive sequences comprising pre-processing directives 410, primary processing directives 411, and post-processing directives 412.

This dual-layer configuration architecture is a distinguishing feature of the invention. Both the transaction type configuration object 200 and the state transition configuration object 400 independently define serialized processing directive sequences. When a transaction is processed, the system resolves and merges directives from both layers to produce a combined execution sequence. This enables the same transaction type (for example, “WITHDRAWAL”) to invoke different processing sequences depending on which state transition it triggers (for example, a withdrawal from an IN_FORCE state may invoke different processors than a withdrawal from a PAID_UP state), while still sharing common processing logic defined at the transaction type level.

While the preferred embodiment employs two configuration layers (transaction type and state transition), the invention encompasses alternative embodiments that achieve runtime pipeline construction from data-store-resident configuration objects through different composition strategies. In a single-layer embodiment, a unified configuration object type defines the complete processing directive sequence for each combination of transaction type and source state, eliminating the merging step while retaining the core principle that processing pipelines are constructed at runtime from serialized directives stored in a data store rather than compiled into application code. In an override-priority embodiment, one configuration layer defines a base processing directive sequence and a second layer defines override directives that replace, insert before, insert after, or remove specific directives from the base sequence, rather than merging by concatenation. In a multi-layer embodiment, three or more configuration layers contribute processing directives; for example, a rider-level configuration layer may add rider-specific processing directives that are composed with the transaction type and state transition directives. In an event-sourced embodiment, processing directive sequences are associated with domain events rather than state transitions; the system derives the current agreement state from a replay of stored events and resolves processing directives from the event type configuration objects. Each of these alternative composition strategies achieves the inventive principle of dynamically constructing computational pipelines from data-store-resident configuration objects without modifying application code.

The composition of processing directives from multiple configuration layers may employ various merging strategies beyond the ordered concatenation described in the preferred embodiment. In a priority-weighted merge, each directive carries a priority value, and directives from different layers are interleaved according to priority rather than layer order. In a conflict-resolution merge, when directives from different layers reference the same processor name, a configurable conflict resolution policy determines whether the first, last, highest-priority, or most-specific-scope directive prevails. In a conditional merge, configuration objects define applicability predicates evaluated at runtime, and only directives whose predicates evaluate to true against the current transaction context are included in the merged sequence. In a graph-based composition, processing directives define dependency relationships rather than sequential ordering, and the execution engine resolves a valid execution order through topological sorting of the dependency graph. These merging strategies may be used individually or in combination, and the invention is not limited to any particular merging mechanism.

In a preferred embodiment, the system stores twenty-two state transition configuration objects defining transitions including: DRAFT to PENDING_REVIEW (triggered by NEW_APPLICATION), PENDING_REVIEW to APPROVED (triggered by UNDERWRITE), APPROVED to BOUND (triggered by APPROVE), BOUND to PENDING_ISSUE (triggered by BIND), PENDING_ISSUE to IN_FORCE (triggered by ISSUE), IN_FORCE to SURRENDERED (triggered by FULL_SURRENDER), IN_FORCE to IN_CLAIM (triggered by DEATH_CLAIM), IN_FORCE to LAPSED (triggered by LAPSE), and others corresponding to the complete agreement lifecycle.

### 1.5 Hierarchical Configuration Inheritance

In a preferred embodiment, the state configuration objects, transition configuration objects, transaction type configuration objects, and lifecycle flow configuration objects are organized in a hierarchical configuration structure that supports multi-level inheritance with override capability. The hierarchy comprises four levels: a carrier-level configuration defining default lifecycle behavior applicable to all products administered by a given insurance carrier; one or more product-family-level configurations (such as annuity, life, or health) inheriting from the carrier-level configuration and defining family-specific defaults; one or more product-version-level configurations inheriting from the product-family level and defining behavior for specific product versions; and agreement-instance-level configurations inheriting from the product-version level and defining any per-agreement overrides.

When the processing engine resolves configuration objects for a given agreement, the engine traverses the hierarchical configuration structure from the agreement-instance level upward, applying the most specific configuration at each level and falling back to the next higher level when no level-specific configuration exists. For example, if a product version defines a custom processing directive sequence for withdrawal transactions, that sequence is used; if no product-version-level override exists, the engine falls back to the product-family-level configuration; and if no product-family-level override exists, the engine falls back to the carrier-level default. This hierarchical resolution mechanism enables the platform to administer products across multiple lines of business (annuities, life insurance, health insurance) from a single infrastructure, sharing common lifecycle behavior at the carrier and family levels while permitting product-specific and agreement-specific customization at lower levels, thereby avoiding the single-product-line restriction of conventional policy administration systems described in the Background.

### 1.6 Three-Phase Transaction Processing Engine

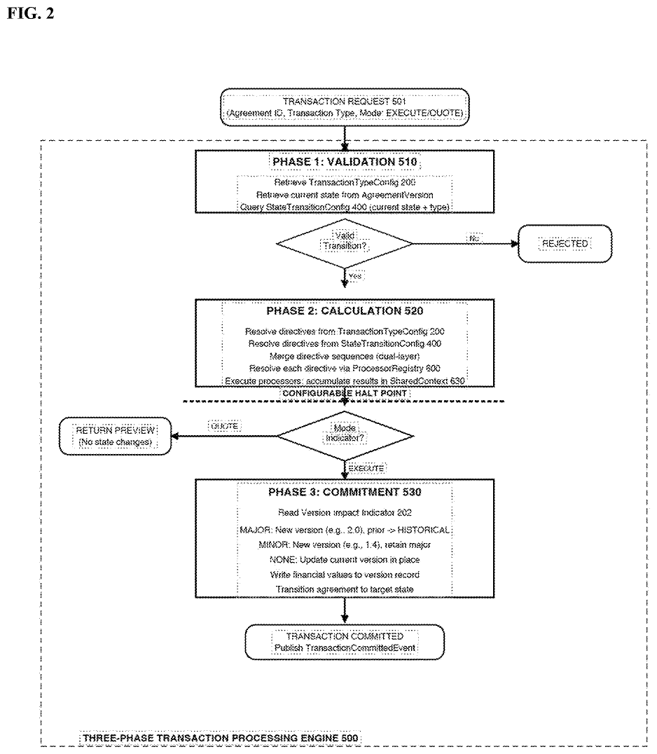

Referring now to FIG. 2, the platform implements a three-phase transaction processing engine 500 that processes transactions against insurance agreements using the configuration objects described above. When the platform receives a transaction request 501 specifying an agreement identifier, a transaction type code, and a transaction mode indicator (specifying either EXECUTE mode or QUOTE mode), the processing engine executes three sequential phases.

In Phase 1 (Validation) 510, the engine retrieves the transaction type configuration object 200 corresponding to the specified transaction type code. The engine retrieves the current state of the agreement from the most recent agreement version record. The engine queries the agreement configuration service to determine whether a valid state transition configuration object 400 exists for the combination of the agreement's current state and the specified transaction type. If no valid transition is found, the engine rejects the transaction and returns a validation error. If a valid transition is found, the engine stores the target state from the transition configuration object and advances the transaction to the VALIDATED lifecycle state.

In Phase 2 (Calculation) 520, the engine resolves the serialized processing directive sequences from both the transaction type configuration object 200 and the matching state transition configuration object 400. The engine passes these directive sequences to a processor execution service, which resolves each directive to a registered processor implementation (as described in Section 2 below), orders the resolved processors by their execution order values, and executes them sequentially against the agreement data. The results of each processor are accumulated into a shared processing context, making upstream processor outputs available to downstream processors. Upon completion of Phase 2, the transaction advances to the CALCULATED lifecycle state.

A distinguishing feature of the invention is the configurable halt point between Phase 2 and Phase 3. When the transaction mode indicator specifies QUOTE mode, the engine halts execution after Phase 2 and returns the calculated results without executing Phase 3. This enables non-destructive preview of transaction outcomes, allowing users or automated systems to evaluate the financial impact of a transaction (such as the surrender value of a policy or the effect of a withdrawal on a guaranteed benefit base) without persisting any state changes. The same processing pipeline that produces final committed results also produces preview calculations, such that quoted and executed outcomes are consistent. This dual-mode execution capability serves both interactive use cases (individual transaction previews) and production-scale regulatory valuation workloads (batch projection across thousands of policies and scenarios), as described in Section 5 below.

While the preferred embodiment implements dual-mode execution through a halt point between the calculation and commitment phases, the invention encompasses alternative mechanisms for achieving non-destructive execution. In a transaction-rollback embodiment, the processing engine executes all three phases (including commitment) within a database transaction scope, then rolls back the database transaction before returning the calculated results, achieving non-persistence through transactional isolation rather than phase halting. In a snapshot-fork embodiment, the engine creates an in-memory copy (snapshot) of the agreement's current state prior to execution, executes the full processing pipeline against the snapshot without modifying the persistent record, and returns the results from the snapshot execution. In a write-aside embodiment, the engine executes all phases but directs commitment operations to a separate projection data store (distinct from the production data store), enabling the projection results to be persisted for batch analysis without affecting production agreement records. In a multi-mode embodiment, the mode indicator supports more than two modes, including a SIMULATE mode that executes calculations with hypothetical input parameters not present on the actual agreement, a BACKDATE mode that recalculates from a prior point in time, and a STRESS mode that applies stressed assumptions, each mode controlling which phases execute and how results are stored. These alternative non-destructive execution mechanisms may be used individually or in combination, and the invention is not limited to any particular mechanism for preventing state persistence during preview or projection calculations.

In Phase 3 (Commitment) 530, executed only when the transaction mode indicator specifies EXECUTE mode, the engine reads the version impact indicator 202 from the transaction type configuration object. When the indicator specifies MAJOR, the engine creates a new agreement version record with an incremented major version number (for example, version 2.0 succeeding version 1.3), marks the prior current version as HISTORICAL, and assigns the new state from the transition configuration object. When the indicator specifies MINOR, the engine creates a new version with an incremented minor version number (for example, version 1.4 succeeding version 1.3). When the indicator specifies NONE, the engine updates the current version record in place without creating a new version. In all cases, financial values computed during Phase 2 (such as updated account values, benefit base values, and surrender charges) are written to the new or updated version record.

The agreement version records maintain a complete temporal history of each agreement's lifecycle. Each version record includes a version status indicator with values of CURRENT, HISTORICAL, or SUPERSEDED, enabling the platform to reconstruct the agreement's state at any point in its history. This version chain supports regulatory audit requirements and enables rollback analysis.

### 1.7 Two-Step Endorsement Processing

The three-phase processing engine supports a two-step endorsement process for modifying existing insurance agreements. In the first step, the platform executes an endorsement transaction in QUOTE mode, creating a minor version of the agreement that contains the proposed endorsement changes (such as modified coverage amounts, added riders, or changed beneficiaries). This minor version is assigned an ENDORSEMENT_QUOTE state and serves as a preview of the proposed changes.

In the second step, upon approval of the endorsement (which may require human-in-the-loop review for endorsements exceeding configurable materiality thresholds), the platform executes a commitment transaction in EXECUTE mode, creating a major version that incorporates the endorsed changes and transitions the agreement to the IN_FORCE state. The minor version used for quoting is marked as SUPERSEDED. This two-step process requires that endorsement changes be reviewed and approved before becoming legally effective while using the same three-phase processing engine for both steps.

### 2. Product-Scoped Processor Architecture

### 2.1 Processor Interface and Registration

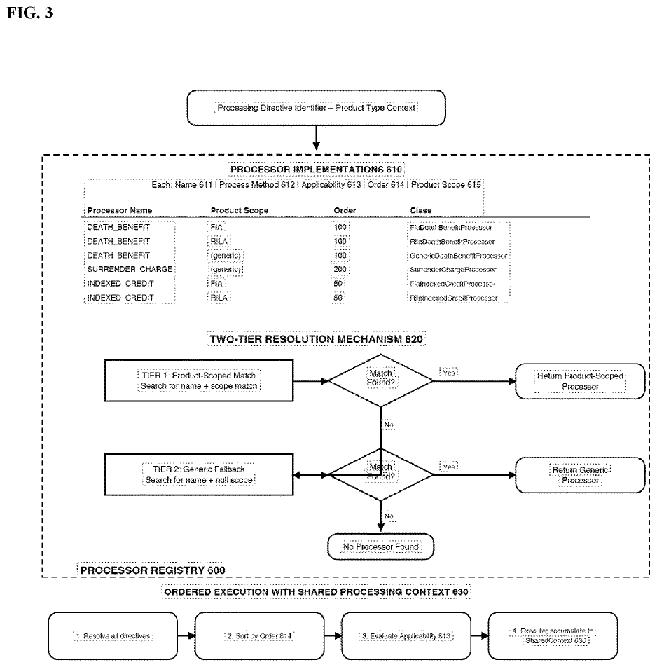

Referring now to FIG. 3, the platform comprises a processor registry 600 that maintains a collection of processor implementations 610. Each processor implementation 610 conforms to a processor interface that defines: a processor name 611 used to identify the processor in configuration directives; a process method 612 that accepts a processing context and returns a processing result; an applicability method 613 that evaluates whether the processor should execute for a given context (defaulting to true); an execution order value 614 that determines the processor's position in the execution sequence relative to other processors (lower values execute first); and a product scope identifier 615 that optionally restricts the processor to a specific product type (a null product scope identifier indicates a generic processor applicable to any product type).

The processor registry 600 automatically discovers and registers all processor implementations 610 available in the platform's runtime environment through dependency injection. Upon initialization, the registry constructs an internal mapping from processor names to lists of processor implementations, where each list may contain one or more implementations with different product scope identifiers.

### 2.2 Product-Scoped Resolution With Generic Fallback

When the processing engine invokes a processing directive (for example, “DEATH_BENEFIT”), the processor registry 600 resolves the directive to a specific processor implementation using a two-tier resolution mechanism 620. In the first tier, the registry searches for a processor implementation whose product scope identifier 615 matches the product type of the agreement being processed. For example, if the agreement is associated with an indexed annuity product, the registry searches for a “DEATH_BENEFIT” processor scoped to indexed annuities. If a product-scoped match is found, the registry returns that implementation.

In the second tier, if no product-scoped match is found, the registry selects a processor implementation with a null product scope identifier as a generic fallback. This two-tier resolution enables the platform to maintain product-specific calculation logic for products that require specialized processing while providing default processing logic for products that do not require specialization. For example, an indexed annuity may require a death benefit calculation that considers high-water mark tracking and guaranteed minimum values, while a traditional fixed annuity may use a simpler calculation. Both are registered under the same processor name (“DEATH_BENEFIT”) but with different product scope identifiers.

While the preferred embodiment employs a two-tier resolution mechanism (product-scoped match followed by generic fallback), the invention encompasses alternative processor resolution strategies that achieve the same goal of resolving processing directives to appropriate implementations based on context. In a priority-ranked resolution embodiment, each processor implementation is assigned a numeric priority score that incorporates factors such as product scope specificity, product family affinity, geographic or regulatory scope, and version recency; the registry evaluates all matching processors, scores each against the current context, and selects the highest-scoring implementation, enabling graduated specificity beyond the binary product-scoped/generic distinction. In a chain-of-responsibility embodiment, processor implementations are organized in a linked chain ordered by specificity, and the registry invokes each processor's applicability evaluation method in chain order, selecting the first processor that accepts the context; this pattern naturally extends to arbitrary numbers of specificity tiers without structural modification. In a direct-binding embodiment, the configuration objects themselves contain explicit references to specific processor implementations rather than abstract directive identifiers, bypassing registry resolution entirely and enabling the configuration author to control exactly which implementation executes; the registry in this embodiment serves as a discovery and validation service rather than a resolution service. In a decorator-composition embodiment, the registry resolves a base processor implementation using any of the above mechanisms and then wraps it in one or more decorator processors that add product-specific pre-processing or post-processing behavior, enabling calculation specialization through composition rather than replacement. Each of these resolution strategies achieves the inventive principle of selecting context-appropriate computational implementations for processing directives defined in data-store-resident configuration objects.

The scope identifiers used for processor resolution are not limited to product type. In alternative embodiments, the scope may be a product family identifier (enabling a single processor to serve all products within the annuity family while a different processor serves all products within the life insurance family), a regulatory jurisdiction identifier (enabling jurisdiction-specific tax calculations or compliance validations), a tenant identifier (enabling tenant-specific calculation customizations in a multi-tenant deployment), or a composite scope comprising multiple dimensions (such as product type combined with regulatory jurisdiction). The resolution mechanism traverses these scope dimensions in a configurable precedence order, enabling fine-grained control over which processor implementation applies in any given context.

2.3 Ordered Execution with Upstream Result Accumulation

When the processing engine receives a sequence of processing directive identifiers from a configuration object, the execution proceeds as follows. First, each directive identifier is resolved to a processor implementation using the two-tier resolution mechanism. Second, the resolved processors are sorted by their execution order values. Third, each processor is evaluated against the processing context using its applicability method; processors that return false are skipped. Fourth, applicable processors are executed sequentially, and the result of each processor is added to a shared processing context 630 under the processor's name.

The shared processing context 630 comprises: agreement information including the agreement identifier, product type, and current state; financial values including account value, cash surrender value, and death benefit amount; living benefit rider indicators specifying which guaranteed benefit riders are active on the agreement; transaction details including the transaction type, amounts, and effective dates; and a prior results mapping 631 that stores the results of previously executed processors indexed by processor name. This prior results mapping enables downstream processors to access upstream processor outputs. For example, a withdrawal processing processor may access the result of a previously executed surrender charge processor to determine the net withdrawal amount after charges.

Each processor returns a processing result comprising: a success indicator; a net amount change value representing the financial impact of the processor's calculation; a calculated values mapping containing named calculation outputs; and a should-apply indicator specifying whether the result should be accumulated into the shared context. When a processor returns a failure result, the execution engine immediately halts execution of remaining processors in the sequence and returns the failure, preventing partial calculation results from being committed. This fail-fast behavior maintains transactional integrity of the processing pipeline.

### 2.4 Exemplary Processor Implementations

In a preferred embodiment, the platform includes processor implementations for insurance benefit calculations including living benefit guarantee processors. A guaranteed lifetime withdrawal benefit (GLWB) suite comprises: a benefit base processor that computes the guaranteed benefit base by applying a rollup rate to the prior benefit base and comparing the rolled-up value against the current account value, selecting the greater of the two (a step-up ratchet mechanism); a charge processor that calculates periodic benefit charges as a percentage of the benefit base or account value based on configuration; and a withdrawal processor that determines the maximum guaranteed annual withdrawal based on age-banded payout rates, calculates any excess withdrawal amount, and applies proportional reduction to the benefit base for excess withdrawals.

A guaranteed minimum withdrawal benefit (GMWB) suite comprises: a benefit base processor that maintains a static benefit base initialized at issue to the total premium paid (without rollup); a charge processor; and a withdrawal processor that implements two-tier processing where withdrawals within the guaranteed amount reduce the benefit base dollar-for-dollar while excess withdrawals apply proportional reduction. A guaranteed minimum accumulation benefit (GMAB) processor calculates a top-up amount when the account value at maturity falls below the guaranteed floor. A guaranteed minimum death benefit (GMDB) processor suite supports three calculation sub-types: annual ratchet (high-water mark tracking), minimum account value, and rollup (compound growth at a configured rate).

In the preferred embodiment, the processor registry maintains processor implementations across the following categories: rate lookup processors that retrieve applicable rates from rate tables based on agreement parameters; indexed crediting strategy processors that calculate periodic credits for fixed indexed annuity and registered index-linked annuity products based on index performance, cap rates, participation rates, and buffer or floor configurations; surrender charge processors that compute applicable surrender charges based on policy duration and surrender charge schedules; death benefit processors including standard return-of-premium, enhanced death benefit, and product-specific death benefit calculations for indexed and registered index-linked products; waiver processors for nursing home confinement and terminal illness benefit waivers; segment management processors for managing indexed crediting segments and buffer configurations; bonus calculation processors for computing and tracking premium bonuses and vesting schedules; guaranteed minimum benefit processors as described above; cost-of-insurance processors for universal life and variable universal life products that compute monthly deductions based on net amount at risk and applicable mortality rates; market value adjustment processors for products with book value accounting; automatic premium loan processors for life insurance products; non-forfeiture option processors for computing reduced paid-up and extended term insurance values; and modified endowment contract testing processors for IRC Section 7702A compliance. In a preferred embodiment, the registry maintains over fifty processor implementations spanning these categories, registered across multiple product types with product-scoped and generic fallback implementations as described above.

These processor implementations serve as exemplary embodiments of the product-scoped processor architecture. Alternative embodiments may include processors for other insurance calculations such as interest crediting, premium allocation, policy loan processing, regulatory reserve computations, and disability income benefit calculations, each registered with the processor registry using the same interface and resolution mechanism.

### 3. Standardized Insurance Data Interchange Pipeline

### 3.1 Interchange Document Transformation

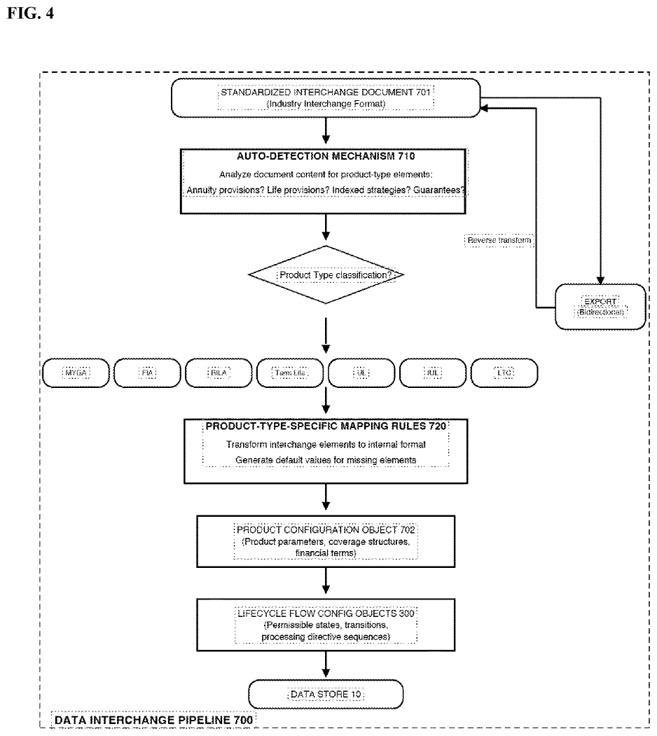

Referring now to FIG. 4, the platform comprises a data interchange pipeline 700 that transforms standardized insurance data interchange documents 701 into product configuration objects 702 that govern agreement lifecycle behavior. The interchange documents conform to an industry interchange format that defines a standardized structure for representing insurance product definitions, coverage parameters, benefit provisions, and financial terms.

In a preferred embodiment, the interchange format is based on a standardized insurance data interchange specification that defines XML-based document structures for representing life insurance and annuity product information. The interchange documents include elements describing policy details, coverage structures, annuity provisions, life insurance provisions, rider definitions, guarantee periods, surrender charge schedules, interest crediting methods, and market value adjustment parameters. Alternative embodiments may use other standardized interchange formats, proprietary interchange specifications, or non-XML data representations such as JSON or protocol buffers.

### 3.2 Auto-Detection and Product-Type-Specific Mapping

The data interchange pipeline 700 includes an auto-detection mechanism 710 that analyzes the content of a received interchange document to determine the product type classification. The auto-detection mechanism examines the presence or absence of product-type-specific data elements within the document. For example, the presence of annuity-specific elements (such as guaranteed minimum accumulation provisions or indexed crediting strategy definitions) in conjunction with the absence of life-insurance-specific elements (such as mortality charge structures or death benefit option definitions) indicates an annuity product type. The auto-detection mechanism classifies products into types including: multi-year guaranteed annuity (MYGA), fixed indexed annuity (FIA), registered index-linked annuity (RILA), term life, whole life, universal life, indexed universal life, variable universal life, long-term care, disability income, and Medicare supplement.

Once the product type is determined, the pipeline applies product-type-specific mapping rules 720 to transform data elements from the interchange document into an internal product configuration object 702. The mapping rules define how interchange elements correspond to internal data structures, handle product-type-specific variations in element interpretation, and generate default values for elements not present in the interchange document. For example, a MYGA product mapping extracts guarantee period rates and durations, while an FIA product mapping extracts index crediting strategies, participation rates, cap rates, and floor rates.

### 3.3 Configuration Generation and Bidirectional Exchange

From the product configuration object 702, the pipeline generates lifecycle flow configuration objects 300 appropriate for the product type. The generated configuration includes: the set of allowed states for the product's lifecycle, the initial state, product-specific flags (such as whether illustration or underwriting is required), and default state transition configurations. This generation process enables the platform to automatically configure lifecycle behavior for newly imported products without manual configuration.

The pipeline supports bidirectional exchange, enabling the platform to export existing product configuration objects as standardized interchange documents. This export capability enables integration with external systems that consume the interchange format, including actuarial modeling systems, reinsurance platforms, and regulatory filing systems.

In an alternative embodiment, the interchange document may be generated by an automated extraction system that analyzes unstructured source documents such as product specification sheets, rate filing documents, or marketing materials. The automated extraction system identifies product parameters within the unstructured documents and produces a standardized interchange document that the pipeline can process through the same auto-detection and mapping mechanisms.

### 4. Integrated Rate Publication Pipeline

The platform comprises a rate publication pipeline 800 that manages the publication and versioning of insurance product rates. The pipeline maintains rate level records 801, each associated with a product identifier 802 and an effective date type 803 that distinguishes between new business rates (applicable to newly issued agreements) and renewal rates (applicable to existing agreements at renewal). Each rate level record has a status lifecycle progressing through PENDING (awaiting approval), ACTIVE (currently in effect), and SUPERSEDED (replaced by a newer rate level).

Upon creation, a rate level record is stored in PENDING status. When approved (by a human approver or through an automated approval process), the pipeline atomically transitions the rate level record to ACTIVE status and transitions any existing ACTIVE rate level record for the same product and effective date type to SUPERSEDED status. This atomic supersession guarantees that at any point in time, at most one ACTIVE rate level exists for each combination of product and effective date type, preventing ambiguity in rate selection during transaction processing.

The dual-track architecture (new business and renewal) enables the platform to maintain independent rate levels for each track. This accommodates business practices where new business and renewal pricing are managed on different schedules or by different organizational units. The pipeline maintains a complete history of rate level transitions including the identity of the approver, the approval timestamp, and the identifier of the superseded rate level, enabling regulatory audit of rate changes over time.

While the preferred embodiment implements rate versioning through atomic status transitions (PENDING to ACTIVE with simultaneous supersession of the prior ACTIVE record), the invention encompasses alternative rate versioning strategies. In an effective-date-resolution embodiment, rate level records carry effective dates and optional expiration dates, and the system resolves the applicable rate at transaction time by selecting the record whose effective date is the most recent date not exceeding the transaction date; no status transitions are required because temporal ordering implicitly determines which rate is current. In a branch-and-merge embodiment, rate adjustments are created as branches from a current rate version, enabling multiple proposed adjustments to coexist for evaluation before a selected branch is merged into the active rate line, analogous to version control branching patterns. In a layered-rate-composition embodiment, rather than maintaining a single active rate record, the system maintains a base rate record and one or more adjustment layer records (for example, a hedge cost adjustment layer, a competitive positioning layer, and a regulatory compliance layer), and the effective rate is computed at transaction time by composing the base rate with all active adjustment layers. These alternative rate versioning mechanisms may be combined with any of the governance and audit mechanisms described herein.

### 5. Valuation Subsystem

### 5.1 Valuation Architecture Overview

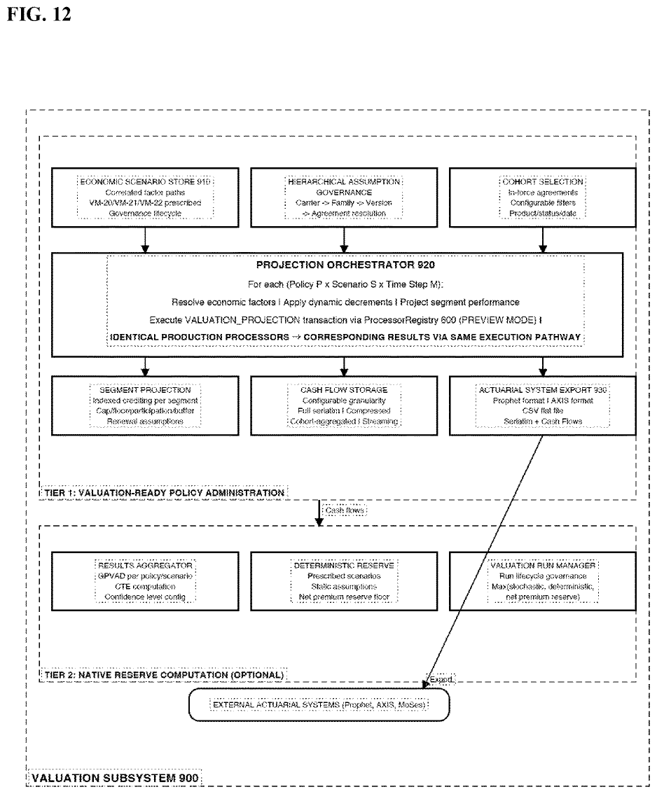

Referring now to FIG. 12, the platform comprises a valuation subsystem 900 that enables carriers to run regulatory reserve projections using the same calculation processors that administer production transactions. The valuation subsystem is organized into two tiers. Tier 1 (Valuation-Ready Policy Administration) provides infrastructure that no external actuarial system can provide on its own: economic scenario storage, hierarchical assumption governance, production-processor-based projections via the preview mode described in Section 1.6, segment-level forward projection under economic scenarios, and structured cash flow exports to external actuarial platforms. Tier 1 is independently valuable whether the carrier computes reserves natively or feeds an external actuarial platform such as Prophet, AXIS, or MoSes. Tier 2 (Native Reserve Computation) optionally provides reserve aggregation, deterministic reserve calculation, and valuation run lifecycle management, replacing the need for a separate actuarial projection system.

### 5.2 Economic Scenario Store

The valuation subsystem comprises an economic scenario store 910 that persists sets of correlated economic scenarios generated by the AI platform's Scenario Generation Agent (described in Section 6.4 below) or imported from third-party generators such as the American Academy of Actuaries scenario generator required by certain regulatory frameworks. Each scenario set contains correlated paths for multiple economic factors (treasury rates at multiple tenors, equity index returns, implied volatilities, credit spreads) over a projection horizon of up to 360 months at configurable time steps. The scenario store does not generate scenarios; it receives, validates, governs, and serves them. This separation is intentional: carriers may use their own approved scenario generators (many regulators require specific generators for certain tests) and the policy administration system must accommodate any source.

Each scenario set record comprises: a source type indicator distinguishing between AI-generated, regulatory-prescribed, and third-party-imported scenarios; a regulatory framework indicator (VM-20, VM-21, VM-22, LDTI, or internal) specifying the regulatory context; a calibration date and calibration method; and a correlation matrix documenting the empirical relationships between economic factors. Scenario sets progress through a governance lifecycle of DRAFT, VALIDATED, APPROVED, and SUPERSEDED states. Only APPROVED scenario sets may be used in projection runs. Prescribed scenarios (those mandated by regulatory frameworks such as the 16 prescribed interest rate scenarios for VM-20/VM-22 deterministic reserves) bypass the approval workflow as they are pre-approved by regulation.

### 5.3 Hierarchical Assumption Governance

Actuarial assumptions for valuation projections follow the same four-level hierarchical configuration structure described in Section 1.5 for lifecycle configuration. Each assumption category (mortality, lapse, partial withdrawal, annuitization, expenses, reinvestment, renewal rates, segment mapping) is stored as a configuration record at one or more levels of the hierarchy: carrier level defining company-wide base assumptions applicable to all product families; product family level overriding carrier defaults for a specific product family such as annuity, life, or health; product version level overriding family defaults for a specific filed product version; and agreement instance level providing per-policy overrides for exceptional cases requiring human-in-the-loop approval.

When the projection orchestrator (described in Section 5.4) resolves assumptions for a given policy, it traverses from the agreement instance level upward, applying the most specific assumption at each category and falling back to the next higher level when no override exists. Each resolved assumption carries provenance metadata indicating which level of the hierarchy supplied it, enabling regulatory examiners to trace: “Carrier default mortality is 2012 IAM Basic with MP-2025 improvement. The annuity family overrides with a 0.95 multiplier for ages 0-65. FIA Gold 2025 v2 does not override mortality (inherits from family). No agreement-level overrides exist.”

Each assumption record comprises: a resolution level indicator; hierarchical scope identifiers (carrier code, product family, product code, agreement identifier as applicable to the level); an assumption category; an assumption type distinguishing between best estimate, prescribed, locked-in (issue-date), and stress test assumptions; a regulatory framework indicator; versioning with effective and termination dates; the assumption data stored as structured data; governance metadata including status (DRAFT, UNDER_REVIEW, APPROVED, SUPERSEDED, REJECTED), approver identity, approval timestamp, and review notes; and sensitivity metadata documenting the calibration date, data period, and credibility weighting.

This hierarchical assumption structure extends the pattern disclosed in Section 1.5 beyond lifecycle configuration to actuarial governance. The same resolution mechanism (traverse from most specific to most general, apply the first match at each category) operates consistently across lifecycle behavior, transaction processing, accounting configuration, and valuation assumptions, creating a unified configuration architecture across the platform.

### 5.4 Projection Orchestrator

The projection orchestrator 920 is the computational core of the valuation subsystem. It executes the three-phase transaction engine described in Section 1.6 in preview mode across the cross-product of: policies (all in-force agreements or a filtered subset), scenarios (all paths in an approved scenario set), and time steps (monthly from valuation date through projection horizon). For each policy, scenario, and time step, the orchestrator submits a synthetic transaction of type VALUATION_PROJECTION through the processor registry, collecting projected cash flows without persisting any state changes.

The projection execution proceeds in four stages. In the initialization stage, the orchestrator loads the policy cohort based on configurable filter criteria (product codes, agreement statuses, issue date ranges), loads scenario set paths, resolves the hierarchical assumption set for each policy, loads segment allocation data per policy from the segment data model, and partitions work into parallel work items based on policy batches and scenario ranges.

In the projection stage, executed in parallel across work items, for each policy P and each scenario S, the orchestrator creates an initial state snapshot from the policy's current financial position as of the valuation date (account value, segment allocations, rider benefit bases, surrender charge schedule). For each projection month M from 1 through the projection horizon: the orchestrator resolves economic factors for month M from scenario S (treasury rates, equity returns, implied volatilities); applies dynamic actuarial assumptions by invoking behavior model processors through the processor registry in preview mode, specifically: a lapse rate processor applying base rates multiplied by dynamic economic sensitivity factors, a withdrawal utilization processor applying utilization rates adjusted by guarantee in-the-moneyness, an annuitization processor applying base rates adjusted by age and guarantee value; applies mortality decrements using the mortality rate processor with applicable improvement scales; projects segment performance by applying the index return from the scenario to each crediting segment through the same indexed crediting processor used for production transactions, respecting cap, floor, participation, buffer, and spread parameters per segment configuration, and handling segment maturity and renewal using scenario-dependent renewal assumptions; executes a preview-mode VALUATION_PROJECTION transaction through the processor registry invoking the same product-scoped processors used for real transactions (indexed credit calculation, rider charge calculation, expense charge calculation, benefit payment calculation); computes monthly cash flows including premiums, charges, benefits, and net flows; and stores the projected cash flow record.

The distinguishing technical contribution of the projection orchestrator is that the processor instances invoked during projection are the identical processor implementations used for production transaction processing. The indexed crediting processor that credits a real fixed indexed annuity segment in a production transaction is the same code that credits a projected segment under an economic scenario. The technical mechanism that enables this reuse is the dual-mode execution capability of the three-phase transaction processing engine (Section 1.6): the projection orchestrator submits each projection step as a VALUATION_PROJECTION transaction with the mode indicator set to preview mode. The processing engine executes the validation and calculation phases, namely: resolving the processing directive sequence from the transaction type configuration object, resolving each directive to a product-scoped processor implementation through the processor registry, executing the processors sequentially with shared processing context, and accumulating results, but halts before the commitment phase. The accumulated results (credited amounts, charge deductions, benefit payments, updated values) are returned as the projection output for that time step without modifying the agreement record in the data store. Because the processor resolution, execution order, applicability evaluation, and shared context accumulation are identical to a production transaction, the projected calculations substantially correspond to production calculations by virtue of executing the same processor instances through the same registry resolution and execution pathway under equivalent inputs. Because no separate implementation of product calculations is required for projection purposes, the quarterly model-to-administration reconciliation associated with maintaining independent actuarial projection systems is avoided. A standalone actuarial system that does not share the administration system's processor implementations cannot achieve this identity by construction and must instead rely on independent reimplementation with periodic calibration.

The reuse of production processor implementations for projection is not limited to the specific preview-mode mechanism described above. In a cloned-processor embodiment, the projection orchestrator instantiates copies of the production processor implementations in a separate execution context dedicated to projection work, such that calculation logic is identical while projection state is isolated from production state. In a shared-library embodiment, both the production transaction engine and the projection orchestrator link against a common calculation library containing the core mathematical logic; neither contains its own implementation of the calculation, thereby achieving identity by shared dependency rather than by preview-mode invocation. In a containerized-processor embodiment, each processor implementation is packaged as a container image, and both the production pipeline and the projection pipeline deploy instances of the same container image, thereby achieving binary-identical calculation logic. In an API-mediated embodiment, the projection orchestrator invokes production processors through an internal API that supports both commit and preview semantics, decoupling the projection orchestrator from the internal structure of the processing engine while preserving calculation identity. The inventive principle, that projection calculations substantially correspond to production calculations by architectural construction rather than by independent reimplementation and calibration, is independent of the specific reuse mechanism employed.

In the output stage, the orchestrator routes results based on a configurable output mode: to internal cash flow storage (described in Section 5.6) for native aggregation; to actuarial system export (described in Section 5.7) for Prophet, AXIS, or CSV format extracts; or directly to a results aggregator (described in Section 5.8) for reserve computation.

### 5.5 Segment Projection Under Economic Scenarios

For indexed products (fixed indexed annuities, registered index-linked annuities, indexed universal life), projecting cash flows requires modeling how each crediting segment performs under each economic scenario. The valuation subsystem records segment-level projection state for each policy, scenario, and month, comprising: the crediting strategy identifier, allocation amount, rate parameters (cap rate, participation rate, floor rate, buffer rate, spread rate, declared rate), the index return from the scenario, the credited rate after applying strategy parameters, the credited amount, and the projected segment value. When a segment's term expires during projection, the orchestrator applies renewal assumptions from the hierarchical assumption set to determine new rate parameters for the renewed segment, with the renewal cap rate derived from the scenario's projected treasury rate at the renewal month, so that segment renewals reflect the specific economic environment of that scenario path.

### 5.6 Projection Cash Flow Storage

The valuation subsystem stores projection cash flows at configurable granularity. Each cash flow record comprises: survival, lapse, and mortality probabilities; monthly undiscounted cash flows (premiums, benefits, expenses, rider charges, commissions, net); end-of-month values (account value, cash surrender value, death benefit, benefit base); summarized segment values; and optional discount factors and present values populated during aggregation. At production scale (10,000 policies across 1,000 scenarios over 360 months), the cash flow storage manages 3.6 billion records per projection run using configurable storage strategies: full seriatim for small books and model validation, compressed seriatim retaining full detail at annual intervals with monthly net flows for production quarterly runs, cohort-aggregated storage for large books, and streaming-to-export where cash flows are written directly to export files without database storage.

### 5.7 Actuarial System Export Interface

For carriers maintaining existing actuarial platforms, the valuation subsystem provides a governed, versioned, self-describing export interface 930 that generates structured data extracts in platform-specific formats. The export interface supports three export types: seriatim-only extracts containing policy-level data (identity, current values, premium history, segment allocations, rider configurations, rate parameters, status); seriatim-with-cash-flows extracts that additionally include projection cash flows from a completed projection run; and cash-flows-only extracts. Export formats include Prophet model point format, AXIS cell-based format, and flat CSV for proprietary or smaller actuarial tools.

The seriatim-with-cash-flows export enables two workflows that address the model-to-administration reconciliation problem from different directions. In benchmark mode, the external actuarial system runs its own projection and compares results against the policy administration system's projected cash flows, so that differences surface model-to-admin discrepancies immediately rather than at quarter-end. In passthrough mode, the actuarial system consumes the policy administration system's projected cash flows directly and performs only reserve aggregation (CTE computation, deterministic reserves), giving the actuarial team their familiar tool for review and governance while eliminating the reconciliation problem at the projection level.

### 5.8 Results Aggregator (Tier 2)

For carriers computing reserves natively (without an external actuarial system), the valuation subsystem comprises a results aggregator 940 that computes reserve measures from projection cash flows. The aggregator implements three reserve methodologies. For the stochastic reserve, the aggregator computes, for each policy and each scenario, the Greatest Present Value of Accumulated Deficiency (GPVAD), where at each future time t, the accumulated deficiency equals the present value of benefits and expenses to time t minus the present value of premiums and investment income to time t minus the current reserve at time t, and the GPVAD for that scenario is the maximum of accumulated deficiency over all t. The aggregator then sorts GPVAD values across all scenarios in descending order and computes CTE(X) as the average of the worst (100-X) percent of scenarios. For VM-22, this is CTE(70), defined as the average of the worst 30 percent.

For the deterministic reserve, the aggregator runs the projection orchestrator with prescribed scenario sets (such as the 16 prescribed interest rate scenarios mandated for VM-20/VM-22) and static assumption sets (without dynamic economic sensitivity in the lapse model), then computes GPVAD under each prescribed scenario and takes the maximum. For the net premium reserve floor, the aggregator computes net premiums using issue-date (locked-in) assumptions and projects the net premium reserve as the present value of future benefits minus the present value of future net premiums.

The final reserve for each policy is determined as the maximum of the stochastic reserve, the deterministic reserve, and the net premium reserve floor (where applicable), with attribution metadata identifying which methodology produced the binding reserve amount and decomposing reserve changes from prior periods into components attributable to new business, lapses, market movements, and assumption changes.

### 5.9 Valuation Run Manager (Tier 2)

The valuation subsystem comprises a valuation run manager 950 that provides end-to-end lifecycle management for regulatory valuation runs with human-in-the-loop governance at key decision points. Each valuation run progresses through stages: CREATED (initial configuration), SCENARIOS_LOADED (economic scenarios attached and validated), ASSUMPTIONS_LOCKED (assumption sets frozen for the run), PROJECTION_RUNNING (executing cash flow projections through the projection orchestrator), PROJECTION_COMPLETE (all projections finished), AGGREGATION_RUNNING (computing reserves), AGGREGATION_COMPLETE (reserves computed), REVIEW (results presented for appointed actuary review), APPROVED (appointed actuary signs off on results), and FINALIZED (results published and locked from modification). Human-in-the-loop approval gates are enforced at assumption locking (the appointed actuary reviews and approves assumptions before projection begins), at aggregation review (the appointed actuary reviews reserve results before approval), and at finalization (the appointed actuary certifies the final reserve amounts).

Carriers using Tier 1 only (exporting to an external actuarial system) do not require the valuation run manager; such carriers run projections ad-hoc and export to their actuarial platform, which manages its own run lifecycle and governance process.

### 6. AI-Orchestrated Asset Liability Management and Hedging Optimization Platform

### 6.1 Agent Orchestration System

In a further aspect of the invention, the configurable lifecycle management platform described above is integrated with an AI-orchestrated platform for asset-liability management (ALM) and hedging optimization. The AI-orchestrated platform employs a plurality of specialized computational agents coordinated through a central orchestration engine to perform data collection, scenario modeling, hedge strategy formulation, reserve projection, and dynamic pricing functions. However, the configurable lifecycle engine (Sections 1-2), the processor architecture (Section 2), the data interchange pipeline (Section 3), the rate publication pipeline (Section 4), and the valuation subsystem (Section 5) are independently operable and do not require the AI orchestration platform described in this section.

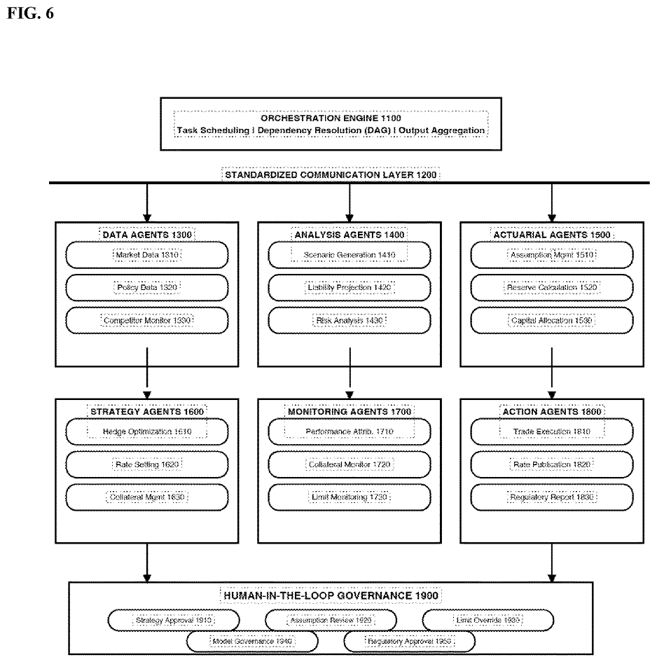

Referring now to FIG. 6, the AI agent orchestration system comprises a hierarchical arrangement of specialized computational agents coordinated through an orchestration engine 1100. The orchestration engine 1100 manages workflow execution, task scheduling, dependency resolution, and output aggregation across all agent categories. The orchestration engine maintains a directed acyclic graph of task dependencies, where each node represents a computational task assigned to a specific agent and edges represent data dependencies between tasks. The engine traverses this graph to determine execution order, parallelizing independent branches and serializing dependent chains. Each task node carries a typed input schema and a typed output schema; the engine validates schema compatibility at task-graph construction time before dispatching work. The agents communicate through a standardized communication layer 1200 using predefined message protocols that enable structured data exchange between agents of different categories. Each message comprises a header (source agent identifier, target agent identifier, message type enumeration, correlation identifier, timestamp) and a typed payload conforming to the target agent's input schema. Message types include DATA_REQUEST, DATA_RESPONSE, TASK_ASSIGNMENT, TASK_RESULT, STATUS_UPDATE, and GOVERNANCE_ESCALATION. The communication layer implements at-least-once delivery with idempotent processing on the receiving agent, thereby preventing duplicate computation from retransmitted messages.

The system includes six primary agent categories. Data Agents 1300 are responsible for gathering and pre-processing information, including: a Market Data Agent 1310 that collects real-time and historical financial market data; a Policy Data Agent 1320 that interfaces with the configurable lifecycle management platform to retrieve agreement data, version histories, and configuration parameters; and a Competitor Monitor Agent 1330 that tracks competitor products and rates.

Analysis Agents 1400 perform analytical functions including: a Scenario Generation agent 1410 that creates economic scenarios for simulation using correlated multi-factor stochastic processes; a Liability Projection agent 1420 that invokes the projection orchestrator (Section 5.4) to project insurance liability cash flows across generated scenarios using the production processor registry; and a Risk Analysis Agent 1430 that evaluates portfolio risks and sensitivities.

Actuarial Agents 1500 handle insurance-specific modeling including: an Assumption Management agent 1510 that maintains and calibrates actuarial assumptions within the hierarchical assumption governance framework (Section 5.3), updating assumptions at the appropriate hierarchy level with audit provenance; a Reserve Calculation agent 1520 that invokes the results aggregator (Section 5.8) to compute statutory and economic reserves in compliance with applicable regulatory frameworks; and a Capital Allocation agent 1530 that determines capital requirements under multiple constraint sets.

Strategy Agents 1600 develop and optimize strategies including: a Hedge Optimization agent 1610 that determines optimal hedging approaches using multi-objective optimization algorithms; a Rate Setting Agent 1620 that calculates competitive product rates incorporating hedge cost feedback; and a Collateral Management agent 1630 that manages collateral requirements for derivative positions.

In a preferred embodiment, the Hedge Optimization Agent 1610 further comprises a decision adaptation module that maintains a structured decision log recording investment manager actions taken in response to system-generated hedge portfolio recommendations. Each decision log entry stores the recommendation presented (including the candidate portfolio composition, objective function values, and constraint satisfaction metrics), the action taken by the investment manager (accept, modify with specific modifications recorded, or reject with stated rationale), the prevailing market conditions at the time of the decision (interest rate levels, volatility surface, credit spreads, equity index levels), and a deviation indicator quantifying the divergence between the recommendation and the action. The decision adaptation module periodically analyzes patterns in the decision log by correlating historical deviations with market condition feature vectors, identifying systematic preference functions (for example, that a particular investment manager consistently increases duration hedging above system recommendations when the yield curve is inverted, or consistently reduces option cost exposure when implied volatility exceeds a historical threshold). These identified preference functions are incorporated as supplemental weighting factors in the multi-objective optimization algorithm, adjusting the scoring of candidate portfolios during subsequent optimization iterations. When presenting new hedge portfolio recommendations, the system displays both the mathematically optimal recommendation and one or more historically-derived alternatives constructed by applying the identified preference functions to the current optimization problem, enabling investment managers to evaluate recommendations informed by institutional decision history while maintaining full transparency into the basis for each alternative.

Monitoring Agents 1700 track performance and compliance including: a Performance Attribution agent 1710 that analyzes portfolio performance and decomposes earnings movements by risk factor; a Collateral Monitoring agent 1720 that tracks collateral usage against limits; and a Limit Monitoring agent 1730 that ensures compliance with risk limits and regulatory thresholds.

Action Agents 1800 execute decisions including: a Trade Execution agent 1810 that implements hedge positions; a Rate Publication agent 1820 that transmits rate adjustments to the rate publication pipeline described in Section 4; and a Regulatory Reporting agent 1830 that generates compliance reports.

Human oversight is enabled through a Human-in-the-Loop (HITL) governance framework comprising user-facing interfaces 1900 that enforce manual approvals, compliance validation, assumption reviews, and override capabilities at configurable decision points within agent workflows. These interfaces include Strategy Approval 1910, Assumption Review 1920, Limit Override 1930, Model Governance 1940, and Regulatory Approval 1950 interfaces.

### 6.2 Alternative Implementation Architectures

While the preferred embodiment utilizes a multi-agent orchestration system, the invention encompasses alternative implementations that may distribute the same functional capabilities across fewer or more agents, components, or services. The number, naming, and organization of agents, services, or components is not a limiting aspect of the invention. The architecture may alternatively be implemented using service-oriented architecture with microservices, function-as-a-service implementations using serverless computing, traditional n-tier application architecture, workflow-driven systems using orchestration engines, or monolithic applications with modular internal components.

The coordination mechanism between computational components is not limited to the centralized orchestration engine described in the preferred embodiment. In a decentralized choreography embodiment, each computational component publishes events to a shared event bus when it completes work, and other components subscribe to relevant event topics and self-activate when their input dependencies are satisfied, without a central orchestrator directing the flow. In a message-queue embodiment, computational components communicate through persistent message queues (such as work queues, publish-subscribe topics, or priority queues), enabling asynchronous decoupled execution where producers and consumers operate independently. In a reactive-stream embodiment, components are connected through reactive data streams that propagate changes automatically (for example, when new market data arrives, the change propagates through a pipeline of transformations (scenario generation, liability projection, hedge optimization) without explicit orchestration). In a workflow-engine embodiment, the sequence of computational steps is defined as a declarative workflow specification (analogous to a business process model) interpreted by a generic workflow engine, rather than by agent-specific orchestration logic. In a peer-to-peer embodiment, computational components discover each other through a registry and negotiate work distribution through bilateral protocols without hierarchical coordination. The inventive principle, namely coordinating distributed computational components to produce integrated ALM, hedging, and pricing outputs with closed-loop feedback to a rate publication pipeline, is independent of the specific coordination mechanism employed.

The communication protocols between computational components are not limited to the structured message format described in the preferred embodiment. In alternative embodiments, components may communicate through shared memory structures, remote procedure call interfaces, RESTful API invocations, GraphQL queries, gRPC streams, or database-mediated communication where one component writes results to a shared data store and another component reads from it. The message types (DATA_REQUEST, DATA_RESPONSE, TASK_ASSIGNMENT, TASK_RESULT, STATUS_UPDATE, GOVERNANCE_ESCALATION) described in the preferred embodiment represent functional categories of inter-component communication; alternative embodiments may implement equivalent functional communication using different message taxonomies, different serialization formats, or implicit communication through shared state rather than explicit message exchange.

### 6.3 Agent Collaboration Patterns

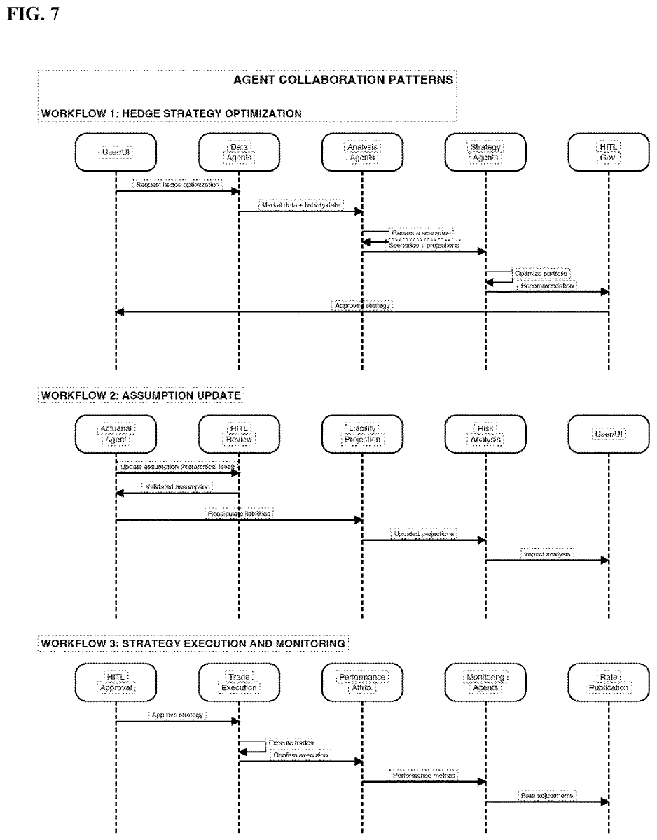

Referring now to FIG. 7, the system employs standardized agent collaboration patterns for key workflows. The Hedge Strategy Optimization Workflow demonstrates the collaborative process: beginning with a request for hedge optimization from the user interface; obtaining market data, liability projections, and policyholder behavior models; generating economic scenarios; developing an optimized strategy; presenting recommendations for human approval through the HITL governance interface.

The Strategy Execution and Monitoring pattern illustrates the implementation workflow: human approval of a hedge strategy; trade execution and confirmation; performance analysis with updated market and liability data; flagging of issues when detected; and presentation of results for human review.

The Assumption Update Workflow demonstrates the governance process: requesting an assumption update; updating behavior assumptions at the appropriate level of the hierarchical assumption governance framework (Section 5.3); requesting and obtaining human validation through the HITL interface; recalculating liabilities with new assumptions through the projection orchestrator; and presenting impact analysis to users.

### 6.4 Hedge Optimization Engine

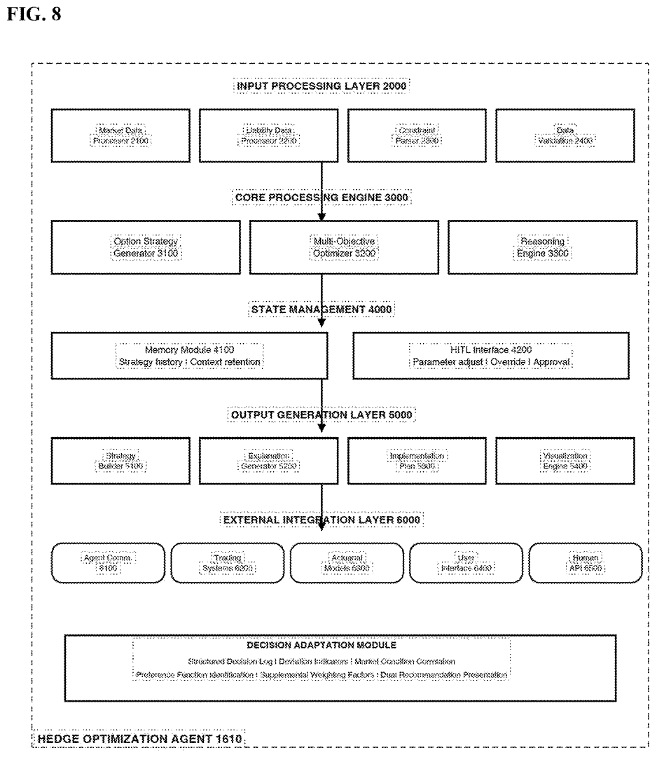

Referring now to FIG. 8, the internal architecture of the Hedge Optimization Agent 1610 comprises multiple specialized components arranged in processing layers. The Input Processing Layer 2000 prepares and validates incoming data through a Market Data Processor 2100, a Liability Data Processor 2200, a Constraint Parser 2300, and a Data Validation component 2400.

The Core Processing Engine 3000 contains: an Option Strategy Generator 3100 that creates candidate hedging approaches using machine-learning-based strategy suggestion, custom strategy templates, lot size optimization, and market pricing validation; a Multi-Objective Optimizer 3200 that balances competing objectives through cost-risk tradeoff balancing, collateral constraint handling, capital impact optimization, and a mixed integer programming solver; and a Reasoning Engine 3300 that provides decision support through strategy evaluation, anomaly explanation, decision justification, and plan formation and assessment.

The State Management component 4000 maintains system context through a Memory Module 4100 that preserves strategy history, market conditions logs, performance tracking, and context retention; and a HITL Interface 4200 that enables human oversight with parameter adjustment, strategy override, approval workflow, and feedback processing capabilities.

The Output Generation Layer 5000 produces actionable outputs through a Strategy Builder 5100, an Explanation Generator 5200, an Implementation Plan generator 5300, and a Visualization engine 5400. The External Integration layer 6000 connects with other systems through Agent Communication 6100, Trading Systems 6200, Actuarial Models 6300, User Interface 6400, and Human API 6500 interfaces.

### 6.5 Multi-Tenant Architecture

The platform supports both single-tenant and multi-tenant deployment models. In the preferred embodiment, a database-per-tenant isolation pattern provides each tenant with a physically separate database instance. A master database stores tenant definitions and API key records (hashed using SHA-256). A dynamic connection pool routing mechanism maintains a pool of database connections for each tenant and routes incoming requests to the appropriate tenant database based on the authenticated API key. Each connection pool is independently configurable with parameters such as maximum pool size, connection timeout, and idle timeout.

This architecture provides the strongest isolation guarantees, preventing any possibility of cross-tenant data leakage while enabling shared infrastructure for the AI orchestration components. Shared resources such as market data feeds and economic scenario libraries are accessible to all tenants through the standardized communication layer while maintaining tenant-specific access controls. Valuation data (scenario sets, assumption sets, projection results, and reserve computations) resides entirely within each tenant's isolated database.

In some embodiments, the multi-tenant architecture further supports periodic batch operations executed across tenant-isolated data stores using the tenant routing mechanism. A batch execution service iterates over all active tenants, establishes tenant context for each tenant using the dynamic connection pool routing mechanism, and executes one or more scheduled batch jobs within the tenant's isolated data store. Exemplary batch operations include: interest crediting jobs that apply periodic interest to active agreement account values; renewal processing jobs that process agreement renewals at term expiration; lapse and cancellation jobs that transition agreements past a grace period to lapsed or cancelled states through the configurable lifecycle engine; annuitization jobs that convert accumulation-phase agreements to payout-phase agreements; valuation snapshot jobs that capture policy financial positions as of a valuation date; and valuation projection jobs that execute the projection orchestrator across a policy cohort. Each batch job executes within the tenant's isolated database context and utilizes the same three-phase transaction processing engine and processor registry described in Sections 1 and 2 for individual transaction processing, thereby maintaining consistency between real-time and batch-processed transactions.

### 6.6 Actuarial and Scenario Modeling

The platform includes actuarial and scenario modeling capabilities comprising nested stochastic simulation with both risk-neutral and real-world scenarios, least-squares Monte Carlo (LSMC) proxy modeling for computational efficiency, and compliance with applicable reserve frameworks. The modeling system features calibration to market and historical data, dynamic policyholder behavior models responsive to changing economic conditions, efficient scenario selection and reduction techniques, and integration with regulatory frameworks.

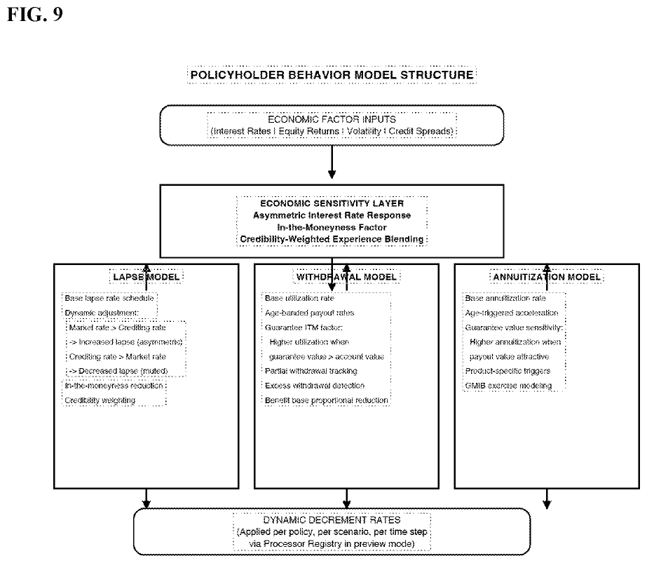

Referring now to FIG. 9, the Policyholder Behavior Model includes three primary components: a Lapse Model, a Withdrawal Model, and an Annuitization Model. Each of these components is responsive to Economic Factor Sensitivity, which includes Interest Rate Differential, Market Performance, In-the-Moneyness of Guarantees, and Market Volatility. The dynamic lapse function implements asymmetric interest rate sensitivity, an in-the-moneyness factor that reduces projected lapses when embedded guarantee values exceed account values, a market shock multiplier, distribution channel adjustments, and credibility-weighted blending with company-specific experience data, as further described in Algorithm 2 below. In the valuation subsystem, these behavior models are invoked as processor implementations through the same processor registry used for production transaction processing, receiving economic scenario factors as input and producing dynamic decrement rates as output.

The system supports multiple execution frequencies for ALM processes, including: quarterly processing aligning with regulatory reporting requirements; monthly processing for more frequent strategy adjustments; daily recalibration for dynamic market environments; and real-time or near-real-time processing for immediate response to significant market events.

### 7. Platform Integration

### 7.1 System Architecture Overview

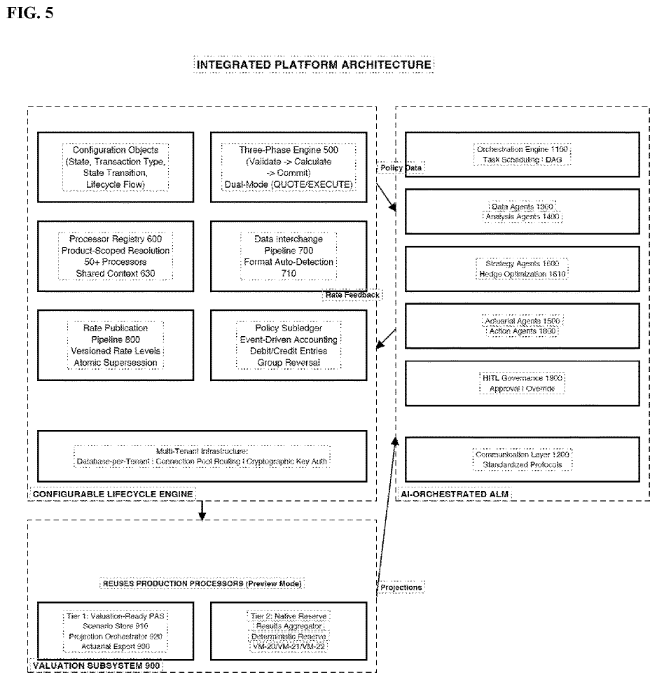

Referring now to FIG. 5, the integrated platform architecture shows the relationship between the configurable lifecycle engine described in Sections 1 and 2, the data interchange pipeline described in Section 3, the rate publication pipeline described in Section 4, the valuation subsystem described in Section 5, and the AI-orchestrated ALM and hedging system described in Section 6. The lifecycle engine and processor architecture form the core transaction processing layer. The data interchange pipeline feeds product configuration into the lifecycle engine. The rate publication pipeline connects the AI-orchestrated system to the lifecycle engine through versioned rate levels. The valuation subsystem consumes and extends the processor registry for regulatory projections. The multi-tenant infrastructure spans all components, providing database-per-tenant isolation throughout.

### 7.2 Hedge-To-Rate Feedback Integration

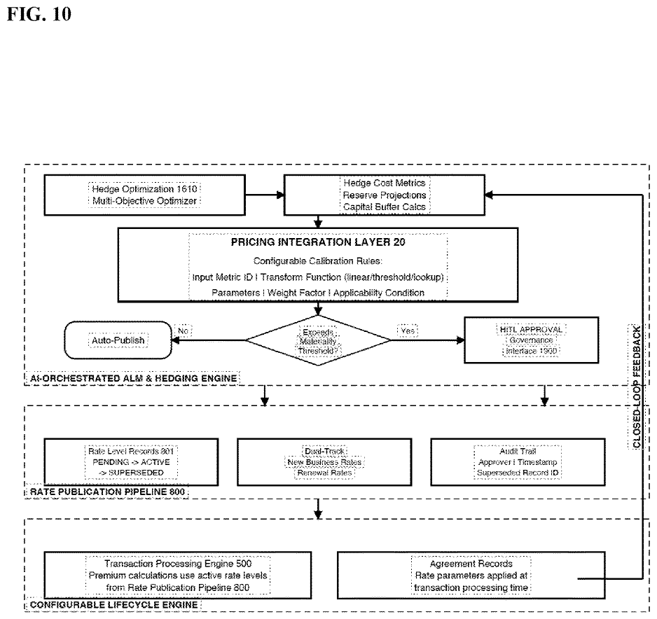

Referring now to FIG. 10, the platform implements a closed-loop feedback mechanism between the AI-orchestrated hedge optimization system and the configurable lifecycle management platform's rate publication pipeline. The pricing integration layer 2500 receives hedge cost metrics, reserve projections, capital buffer calculations, and other outputs from the ALM and hedging engine. The pricing integration layer transforms these metrics into tenant-specific rate adjustment recommendations using configurable rate calibration rules that factor collateral utilization, risk-based capital constraints, and competitive benchmark data. In a preferred embodiment, each calibration rule is a stored configuration record comprising: an input metric identifier (e.g., hedge_cost_ratio, collateral_utilization, basis_risk_measure, rbc_impact), a transformation function type (linear scaling, threshold-based step function, or lookup table), function parameters (slope, intercept, threshold values, or table entries), a weight factor for combining multiple rule outputs, and an applicability condition specifying the product types and rate tracks to which the rule applies. The pricing integration layer evaluates each applicable calibration rule against the received metrics, computes a per-rule rate adjustment component, and aggregates the components using the weight factors to produce a composite rate adjustment recommendation. For example, a hedge_cost_ratio input of 0.015(1.5% of notional) with a linear scaling rule (slope: 1.1, intercept: 0.002) produces a rate component of 0.0185, which after weighting and aggregation with collateral and capital components yields the final rate adjustment. Each computation step and intermediate value is logged to an audit record for regulatory examination.

The rate adjustment recommendations are transmitted through a programmatic publication mechanism to the rate publication pipeline described in Section 4. The publication mechanism supports both real-time transmission for immediate rate adjustments and scheduled batch transmission at configurable intervals. Tenant-specific regulatory and business constraints are applied to each rate adjustment, including minimum and maximum rate boundaries, rate change magnitude limits, and regulatory filing requirements.

The pricing integration layer includes a human-in-the-loop approval mechanism that applies configurable materiality thresholds. Rate adjustments below a configured threshold may be published automatically, while adjustments exceeding the threshold require manual review and sign-off through the HITL governance interface before transmission to the rate publication pipeline. All rate adjustments are logged with full attribution including the originating hedge metrics, the calibration rules applied, and the approval decision, creating an audit trail suitable for regulatory examination.

### 7.3 Simulation and What-If Analysis

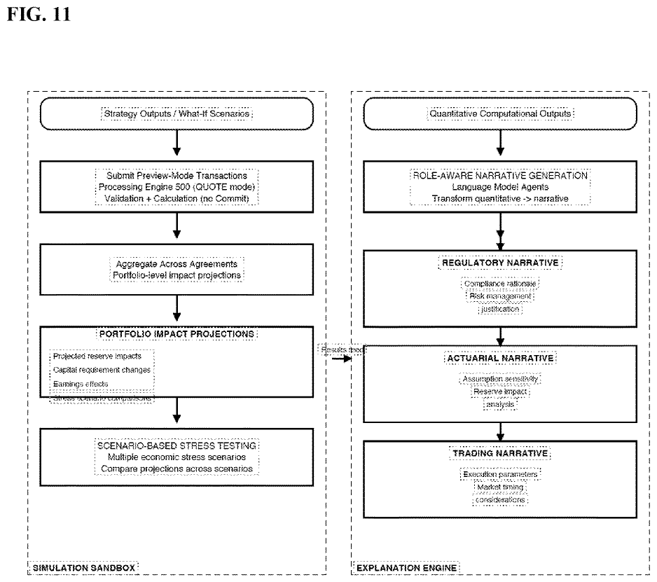

Referring now to FIG. 11, the platform provides simulation and what-if analysis capabilities by employing the dual-mode transaction processing described in Section 1.6 and the projection orchestrator described in Section 5.4. Users or automated systems submit transactions in preview mode to evaluate the financial impact of proposed changes without persisting state modifications. The three-phase processing engine executes the full validation and calculation pipeline, including all configured processors, and returns detailed financial impact projections including projected reserve impacts, capital requirement changes, and earnings effects.

The simulation capabilities extend to hedge and rate strategy testing. Before deploying new hedge strategies or rate changes to production, users can simulate the impact on existing agreements by processing representative transactions in preview mode. The simulation sandbox aggregates results across multiple simulated transactions to produce portfolio-level impact assessments. The valuation subsystem's projection orchestrator enables production-scale simulation by executing the full projection across all in-force policies under candidate assumption sets or rate changes, providing prospective reserve impact analysis before assumptions or rates are approved.

### 7.4 Explanation Engine

The platform comprises an explanation engine that generates role-specific analytical narratives from quantitative hedging and pricing outputs. In a preferred embodiment, the explanation engine employs one or more language model agents to produce natural language justifications for hedging decisions, rate changes, and risk attribution. The narratives are formatted for specific stakeholder contexts: regulatory narratives emphasize compliance and risk management rationale; actuarial narratives focus on assumption sensitivity and reserve impacts; and trading narratives highlight execution parameters and market timing considerations.

### 7.5 Conversational Interface

A role-aware conversational interface allows actuaries, traders, and risk officers to interact with the platform via natural language queries. The interface translates natural language into financial operations within the ALM and hedging framework, provides context-aware responses with detail levels appropriate to the user's role, and generates visualizations from verbal descriptions.

### 8. Exemplary Algorithms

### 8.1 Algorithm 1: Multi-Objective Integer-Constrained Hedge Portfolio Optimizer

The hedge optimization engine implements a multi-objective optimization algorithm that constructs optimal derivative portfolios for insurance liabilities. The algorithm incorporates multiple objectives through a weighted combination of variance minimization and expected shortfall reduction, formulated as: Minimize (1-α)×Variance +α×Shortfall, where α is a configurable risk aversion parameter in [0,1].

The algorithm handles real-world constraints including integer lot sizes for derivative contracts, maximum collateral requirements for each stress scenario, maximum number of options per expiry date, cost constraints limiting total portfolio expenditure, and coverage ratio constraints requiring minimum hedge coverage relative to projected liabilities. A distinguishing computational technique is the progressive refinement approach: the algorithm first relaxes integer constraints and solves the continuous optimization problem, then gradually tightens constraints and re-solves, and finally applies full integer constraints in the final iteration. This progressive approach overcomes computational limitations of mixed integer programming for large option sets, finding near-optimal solutions within reasonable computation times.

8.2 Algorithm 2: Dynamic Lapse Function with Economic Sensitivity

The platform implements a dynamic policyholder behavior model (illustrated in FIG. 9) that calculates lapse rates responsive to changing economic conditions. The model implements asymmetric interest rate sensitivity: policyholders respond more strongly to rising external rates than falling rates, reflecting empirical observations that lapses increase when market rates exceed crediting rates but decrease less when the differential reverses. The model further incorporates an in-the-moneyness factor that reduces projected lapses when embedded guarantees are valuable (guarantee value exceeds account value), a market shock multiplier for periods of significant market disruption, distribution channel adjustments, and credibility-weighted blending with company-specific experience data. Reasonable bounds prevent extreme projections.

### 8.3 Algorithm 3: Multi-Factor Economic Scenario Generator

The platform implements a correlated multi-factor economic scenario generator that creates realistic market simulations for liability projection and hedge optimization. The algorithm generates correlated paths for equity indices (using geometric Brownian motion), interest rates (using mean-reverting processes), and implied volatilities (using GARCH-type processes). A Cholesky decomposition of the empirical correlation matrix preserves observed relationships between market factors. Risk-neutrality adjustments enforce no-arbitrage conditions for derivative pricing. An optional scenario reduction technique selects representative scenarios that preserve distributional properties while reducing computational burden. Generated scenarios are stored in the economic scenario store (Section 5.2) and served to both the projection orchestrator (Section 5.4) and the hedge optimization engine (Section 8.1).

### 9. Additional Embodiments

### 9.1 Game-Theoretic Modeling

In certain embodiments, the AI-orchestrated platform incorporates game-theoretic models to simulate strategic interactions between insurers, reinsurers, policyholders, and capital markets participants. These models evaluate optimal hedging or pricing decisions under adversarial, cooperative, or probabilistic scenarios using concepts such as Nash equilibria, Bayesian games, or Stackelberg competition. For example, the system may simulate competitor rate-setting behavior, reinsurer capacity constraints, or investor preference shifts to enable dynamic adaptation of strategies under various market regimes.

### 9.2 Legacy System Integration

The platform includes specialized data extraction, transformation, and loading capabilities designed for insurance legacy systems, including adapters for common policy administration systems, extract templates for actuarial modeling systems, validation rules for verifying data consistency, reconciliation processes for confirming transformed data accuracy, and incremental data processing for managing large datasets efficiently.

### 9.3 Progressive Model Sophistication

The platform implements a progressive approach to model sophistication that accommodates varying technology maturity. Organizations may begin with industry-standard tools and methods, incorporate more sophisticated machine learning and AI techniques as confidence increases, maintain parallel processing of traditional and advanced approaches for validation, and reconcile between legacy methods and advanced algorithms.

### 9.4 Product Lifecycle Validation Subsystem

In some embodiments, the platform further comprises a validation subsystem configured to execute a product-type-specific sequence of transactions through the configurable lifecycle engine, verifying end-to-end processing across the validation, calculation, and commitment phases. The validation subsystem defines product-type-specific workflow sequences that exercise the complete lifecycle path for each supported product type, including agreement creation, party assignment, quote generation, illustration, application submission, issuance, and post-issue transactions. The validation subsystem submits each workflow step using the three-phase transaction processing engine and accumulates identifiers from each step's response to chain into subsequent steps, enabling automated verification that the lifecycle configuration, processor implementations, and state transitions function correctly for each product type.

### 9.5 Policy-Level Financial Subledger

In a preferred embodiment, the platform comprises a policy-level financial subledger that records accounting transactions generated by the three-phase transaction processing engine. Each committed transaction that triggers accounting entries generates a financial transaction set comprising paired debit and credit entries across policy-level subledger accounts. The subledger maintains accounts for premium receivables, policy account value, surrender charges, commission obligations, and other financial positions, with balances that reconcile to the agreement's financial state in the lifecycle engine. The subledger supports both cash basis and accrual accounting, maintains period-close snapshots, and generates journal entries for transmission to external general ledger systems. Premium waterfall processing decomposes premium payments into component allocations (base premium, rider charges, administrative fees, state premium tax) through configurable waterfall processors registered in the processor registry, enabling carrier-specific premium allocation rules without code changes.

A distinguishing architectural feature of the policy-level financial subledger is that accounting entry generation is derived from the same transaction type configuration objects (Section 1.3) that govern the processing pipeline, rather than maintained as a separate accounting configuration. When the three-phase transaction processing engine completes the commitment phase (Phase 3) for a transaction, the engine publishes a transaction-committed event carrying the committed transaction record. A subledger event listener, operating in a separate transactional scope so that accounting failures do not roll back the committed agreement state change, receives the event and resolves the applicable accounting entry pattern by mapping the transaction type code from the transaction type configuration object to an accounting group type through a transaction-type-to-accounting routing table. The routing table associates each transaction type code (for example, PREMIUM_PAYMENT, WITHDRAWAL, FULL_SURRENDER, DEATH_CLAIM, INTEREST_CREDIT) with a corresponding accounting group type that determines the specific pattern of debit and credit entries to generate. For example, a WITHDRAWAL transaction generates a debit to the policy account value sub-account for the gross withdrawal amount, a debit to the surrender charge reserve sub-account if a surrender charge was computed during the calculation phase, and a debit to the tax ledger sub-account if tax withholding was computed. The sub-account types maintained by the subledger comprise: account value, surrender charge reserve, rider benefit base, withdrawal ledger, death benefit reserve, tax ledger, and fee ledger. Each accounting entry records the entry category, sub-account type, direction (debit or credit), amount, running balance after the entry, effective date, and entry status. Because the transaction type code that determines the accounting pattern is the same transaction type code that resolved the processing directive sequences in Section 1.3, the accounting treatment is architecturally coupled to the processing logic: any change to the transaction type configuration that modifies the processing pipeline automatically maps to the correct accounting pattern without requiring a parallel accounting configuration change. This eliminates the reconciliation burden that arises in conventional systems where processing logic and accounting rules are configured independently.

The subledger further comprises an entry group reversal mechanism that maintains full accounting auditability. Each set of accounting entries generated from a single committed transaction is grouped into an entry group with a group status (POSTED or REVERSED). When an entry group is reversed, the reversal mechanism creates a new entry group of type REVERSAL containing entries with directions opposite to the original entries (debits become credits and vice versa), links each reversal entry to its corresponding source entry, marks the original entries as REVERSED, and recalculates running balances for all subsequent entries from the reversal effective date forward. The policy account maintains a lifecycle status of OPEN, FROZEN (upon death claim, preventing further debits while claim processing completes), or CLOSED (upon surrender, cancellation, or lapse), with the status transition triggered by the accounting group type of the committed transaction.

### 9.6 Multi-Product-Line Administration

In a preferred embodiment, the platform administers insurance products across multiple lines of business, including annuity, life insurance, and health insurance, from a single infrastructure. The product taxonomy defines product families (annuity, life, health) and product types within each family (for annuity: MYGA, FIA, RILA, SPIA, DIA; for life: term, whole, universal, indexed universal, variable universal; for health: long-term care, disability income, Medicare supplement). Each product type has product-scoped processor implementations registered in the processor registry (Section 2), product-specific lifecycle flow configurations (Section 1.4), and product-family-level defaults in the hierarchical configuration structure (Section 1.5). The unified data model stores agreements across all product lines in common tables with product-type-specific attributes stored as structured data extensions, enabling cross-product-line reporting, unified policyholder views, and cross-product servicing. The calculator factory pattern routes calculation requests to the appropriate product-scoped processor based on the agreement's product type, enabling the same indexed crediting processor to serve both fixed indexed annuity and indexed universal life products while layering product-specific processors (such as cost-of-insurance for life products) through the ordered execution sequence.

### 9.7 Cross-Cutting Alternative Embodiments

The architectural patterns described in Sections 1 through 9 may be combined, substituted, and rearranged in various configurations without departing from the scope of the invention. The following cross-cutting alternative embodiments apply across multiple sections of the disclosure.

Data store alternatives. While the preferred embodiment stores configuration objects, rate level records, agreement version records, and projection cash flows in relational database tables, these data structures may alternatively be stored in document databases (such as MongoDB or CouchDB), column-family stores (such as Cassandra or HBase), key-value stores (such as Redis or DynamoDB), graph databases, in-memory data grids, flat file systems, object storage, or hybrid storage architectures combining multiple storage technologies. The term “data store” as used throughout this specification and claims encompasses any persistent or semi-persistent storage mechanism capable of storing and retrieving structured data, and is not limited to relational databases.

Configuration representation alternatives. While the preferred embodiment represents processing directive sequences as ordered lists of string identifiers stored in relational database columns, alternative representations include JSON or XML documents, domain-specific configuration languages, visual workflow definitions, rule engine specifications (such as Drools or CLIPS rule sets), decision tables, BPMN process definitions, finite state machine specifications, Petri net models, or executable code snippets stored as data (such as expression language statements or scripted rules evaluated at runtime). The inventive concept of externalizing processing logic into data-store-resident configuration objects applies regardless of the specific representation format.

Execution model alternatives. While the preferred embodiment executes processors sequentially with ordered execution and upstream result accumulation, alternative execution models include parallel execution of independent processors with synchronization barriers, reactive execution where processors subscribe to data changes and activate automatically, pipeline execution where processors are connected through data streams, and batch execution where multiple transactions are grouped and processed together. The shared processing context may be implemented as a mutable in-memory map (as described), an immutable context passed through a functional pipeline, an event log from which state is derived, or a blackboard architecture where processors read from and write to a shared knowledge base.

Deployment model alternatives. While the preferred embodiment describes a server-based deployment with multi-tenant database-per-tenant isolation, the platform may alternatively be deployed as a single-tenant installation, as a containerized microservice mesh, as a serverless function composition, as an edge-deployed application, or as a hybrid cloud/on-premises deployment. The multi-tenant isolation mechanism may alternatively employ schema-per-tenant isolation (separate schemas within a shared database), row-level-security isolation (shared tables with tenant discriminator columns and database-enforced access policies), or virtual-database isolation (logical database separation within a shared physical infrastructure).

The foregoing detailed description has been presented for purposes of illustration and description. It is not intended to be exhaustive or to limit the invention to the precise forms disclosed. Many modifications, variations, and alternative embodiments are possible in light of the above teaching. The described embodiments were chosen to best explain the principles of the invention and its practical applications, enabling others skilled in the art to utilize the invention in various embodiments and with various modifications suited to the particular use contemplated. It is intended that the scope of the invention be defined by the claims appended hereto and their equivalents.

What is claimed is:

1. A computer-implemented method for dynamically constructing and executing computational pipelines from data-store-resident configuration objects to process state transitions of financial agreement records, comprising: (a) storing, in one or more data stores, a plurality of state configuration objects, each state configuration object defining a permissible state for financial agreement records and comprising properties specifying at least: whether the state is a terminal state from which no further transitions are permitted, whether agreement data is editable in the state, and whether new versions of an agreement record may be created in the state; (b) storing, in the one or more data stores, a plurality of transaction type configuration objects, each transaction type configuration object comprising: a transaction type identifier, a version impact indicator specifying whether a transaction of the type creates no new version, a minor version, or a major version of an agreement record, and at least one serialized processing directive sequence defining computational operations to execute when a transaction of the type is processed; (c) storing, in the one or more data stores, a plurality of state transition configuration objects, each state transition configuration object comprising: a source state identifier, a target state identifier, a transaction type identifier, and at least one serialized processing directive sequence independent of the processing directive sequence of the corresponding transaction type configuration object; (d) receiving, by a processing system, a transaction request associated with a financial agreement record, the transaction request specifying a transaction type and a mode indicator specifying either a preview mode or a commit mode; (e) determining, by the processing system, a current state of the financial agreement record from a most recent agreement version record; (f) identifying a matching state transition configuration object from the plurality of state transition configuration objects based on the current state and the specified transaction type; (g) resolving the serialized processing directive sequences from both the matching state transition configuration object and the corresponding transaction type configuration object to produce a combined set of processing directives; (h) executing the combined set of processing directives against data of the financial agreement record through a calculation phase that resolves each directive to a registered processor implementation and accumulates results into a shared processing context; (i) when the mode indicator specifies the preview mode, returning the accumulated results from the calculation phase without persisting state changes to the data store; and (j) when the mode indicator specifies the commit mode, persisting state changes and transitioning the financial agreement record to the target state defined by the matching state transition configuration object.

2. The method of claim 1, wherein executing the combined set of processing directives further comprises: a validation phase that verifies the transaction request against the state configuration objects and the state transition configuration objects and advances the transaction to a validated lifecycle state prior to the calculation phase; and wherein the commit mode of step (j) further comprises reading the version impact indicator from the transaction type configuration object and creating a new agreement version record based on the version impact indicator, updating a version status of a prior agreement version record, and assigning the target state to the new agreement version record.

3. The method of claim 1, wherein each of the transaction type configuration objects and the state transition configuration objects independently defines serialized processing directive sequences comprising: a pre-processing directive sequence, a primary processing directive sequence, and a post-processing directive sequence, and wherein resolving the processing directive sequences comprises merging the directive sequences from both configuration objects to produce the combined set of processing directives.

4. The method of claim 1, wherein the commitment phase further comprises: reading the version impact indicator from the transaction type configuration object; when the version impact indicator specifies a major version: creating a new agreement version record with an incremented major version number, updating a version status of a prior agreement version record from current to historical, and assigning the target state to the new agreement version record; when the version impact indicator specifies a minor version: creating a new agreement version record with an incremented minor version number while retaining a current major version number; and when the version impact indicator specifies no new version: persisting changes to a current agreement version record without creating a new version record.

5. The method of claim 1, further comprising storing, in the one or more data stores, product-specific lifecycle flow configuration objects, each lifecycle flow configuration object associated with a product identifier and comprising: a list of allowed states serialized as structured data defining which states from the plurality of state configuration objects are available for agreements of the associated product, and a list of skipped states serialized as structured data defining which states are bypassed; and wherein identifying the matching state transition configuration object further comprises filtering available state transition configuration objects based on the lifecycle flow configuration object associated with the insurance agreement's product.

6. The method of claim 2, further comprising processing an endorsement to an existing insurance agreement by: executing a first transaction with the mode indicator specifying preview mode, thereby creating a minor agreement version record containing proposed endorsement changes without executing the commitment phase; and upon approval of the endorsement, executing a second transaction with the mode indicator specifying commit mode, thereby creating a major agreement version record incorporating the endorsed changes through the commitment phase and transitioning the agreement to an active state.

7. The method of claim 1, wherein the state configuration objects, the transition configuration objects, and the transaction type configuration objects are organized in a hierarchical configuration structure comprising: a carrier-level configuration defining default lifecycle behavior applicable to all products administered by a carrier; one or more product-family-level configurations, each inheriting from the carrier-level configuration and defining lifecycle behavior defaults for a product family; one or more product-version-level configurations, each inheriting from a product-family-level configuration and defining lifecycle behavior for a specific product version; and one or more agreement-instance-level configurations, each inheriting from a product-version-level configuration and defining per-agreement overrides; and wherein resolving the serialized processing directive sequences comprises traversing the hierarchical configuration structure from the agreement-instance level upward, applying the most specific configuration at each level and falling back to the next higher level when no level-specific configuration exists.

8. The method of claim 1, wherein resolving serialized processing directive sequences in step (g) comprises: maintaining, in a processor registry stored in memory, a collection of processor implementations, each processor implementation having a processor name, an execution order value, and optionally a product scope identifier restricting the processor implementation to a specific product type; for each processing directive identifier in the resolved sequences, searching the collection for a processor implementation whose processor name matches the processing directive identifier and whose product scope identifier matches a product type context associated with the financial agreement record, and when no product-scoped match is found, selecting a processor implementation whose processor name matches the processing directive identifier and whose product scope identifier is absent, as a generic fallback; and ordering the resolved processor implementations by their execution order values before execution.

9. The method of claim 1, further comprising automatically generating the state configuration objects, the transaction type configuration objects, and the state transition configuration objects from a standardized insurance data interchange document by: analyzing content of the interchange document to automatically determine a product type classification by examining the presence or absence of product-type-specific data elements within the interchange document; selecting product-type-specific mapping rules corresponding to the determined product type classification; applying the selected mapping rules to transform data elements from the interchange document into a product configuration object comprising product parameters, coverage structures, and financial terms; and generating, from the product configuration object, the plurality of state configuration objects, transaction type configuration objects, and state transition configuration objects that govern subsequent state transition processing through the configurable state machine.

10. The method of claim 9, wherein analyzing the content to determine the product type classification comprises: parsing the interchange document to identify the presence of product-type-specific elements including annuity-specific elements, life-insurance-specific elements, indexed-crediting-strategy elements, and guarantee-specific elements;
and classifying the product type into one of a plurality of product type classifications based on which combination of product-type-specific elements are present in the interchange document.

11. The method of claim 9, further comprising: exporting an existing product configuration object as a standardized interchange document conforming to the industry interchange format, enabling bidirectional data exchange between the lifecycle management system and external systems; and wherein the standardized insurance data interchange document is optionally generated by an automated extraction system that analyzes unstructured source documents, identifies product definition parameters within the unstructured source documents, and produces the interchange document in the industry interchange format.

12. The method of claim 1, further comprising generating accounting entries from committed transactions by: upon completion of step (j), publishing a transaction-committed event carrying the committed transaction record; receiving the transaction-committed event in a subledger event listener operating in a separate transactional scope from the commitment of step (j); resolving an accounting entry pattern by mapping the transaction type identifier from the transaction type configuration object to an accounting group type through a transaction-type-to-accounting routing table stored in the one or more data stores; and generating, according to the resolved accounting entry pattern, one or more paired debit and credit entries across policy-level sub-accounts, wherein the transaction type identifier that determines the accounting entry pattern is the same transaction type identifier that resolved the serialized processing directive sequences in step (g), such that the accounting treatment is architecturally derived from the transaction type configuration object that governed the processing pipeline without requiring a separate accounting configuration.

13. A computer-implemented system for resolving and executing computational operations through a product-scoped processor registry with two-tier resolution, comprising: (a) a processor registry stored in memory of one or more computing devices, the processor registry maintaining a collection of processor implementations, each processor implementation having: a processor name matching a processing directive identifier used in configuration objects, an execution order value determining a relative execution position, and optionally a product scope identifier restricting the processor implementation to a specific product type; (b) a resolution mechanism that, given a processing directive identifier and a product type context associated with an insurance agreement, resolves a processor implementation by: searching the collection for a processor implementation whose processor name matches the processing directive identifier and whose product scope identifier matches the product type context, and when no product-scoped match is found, selecting a processor implementation whose processor name matches the processing directive identifier and whose product scope identifier is absent, as a generic fallback; (c) an execution engine that, given a sequence of processing directive identifiers from a configuration object stored in a data store: resolves each processing directive identifier to a processor implementation using the resolution mechanism, orders the resolved processor implementations by their execution order values, evaluates an applicability condition of each resolved processor implementation against a shared processing context, executes each applicable processor implementation sequentially, and accumulates a result from each executed processor implementation into the shared processing context under the processor implementation's name, making the result accessible to subsequently executed processor implementations in the sequence.

14. The system of claim 13, wherein the shared processing context comprises a mapping of processor names to processor results, and wherein a processor implementation accesses results produced by a previously executed processor implementation through the mapping to perform calculations dependent on upstream processor outputs.

15. The system of claim 13, wherein the execution engine, upon receiving a failure result from a processor implementation, immediately halts execution of remaining processor implementations in the sequence and returns the failure result without accumulating partial results into the shared processing context.

16. The system of claim 13, wherein the collection of processor implementations comprises a plurality of insurance benefit calculation processors including: a benefit base calculation processor that computes a guaranteed benefit base using a rollup rate applied to a prior benefit base and a comparison against an account value to select a greater of a rolled-up value and the account value; a charge assessment processor that calculates periodic charges as a percentage of the guaranteed benefit base or the account value based on a charge basis configuration; and a withdrawal processing processor that determines a maximum guaranteed withdrawal based on age-banded payout rates and applies proportional reduction to the guaranteed benefit base when a withdrawal amount exceeds the maximum guaranteed withdrawal.

17. The system of claim 13, further comprising: one or more data stores storing a plurality of state configuration objects each defining a permissible state for insurance agreements and comprising properties specifying whether the state is a terminal state, whether agreement data is editable in the state, and whether new versions of an agreement record may be created in the state; and a plurality of state transition configuration objects each comprising a source state identifier, a target state identifier, a transaction type identifier, and at least one serialized processing directive sequence independent of the processing directive sequence of the corresponding transaction type configuration object; wherein the transaction processing engine is further configured to: receive a transaction request associated with an insurance agreement; determine a current state of the insurance agreement from a most recent agreement version record; identify a matching state transition configuration object based on the current state and a specified transaction type; resolve serialized processing directive sequences from both the matching state transition configuration object and the corresponding transaction type configuration object to produce a combined set of processing directives; and support a preview mode in which execution halts after the calculation phase and returns calculated results without executing the commitment phase.

18. The system of claim 13, wherein the product-scoped processor registry stores insurance agreement records across a plurality of product lines including annuity products, life insurance products, and health insurance products, with product-type-specific attributes stored as structured data extensions to common agreement record structures; and wherein the processor registry maintains processor implementations scoped to specific product types within different product families, together with generic processor implementations applicable across product types, enabling cross-product-line reporting, unified policyholder views, and cross-product servicing from a single infrastructure.

19. A computer-implemented method for processing financial agreement transactions using runtime-constructed computational pipelines, comprising: (a) maintaining, in one or more data stores, a plurality of configuration objects, each configuration object associating at least one processing directive sequence with a transaction context defined by one or more of: a transaction type, a current agreement state, a target agreement state, and a product type; (b) receiving a transaction request for a financial agreement record;
(c) resolving, from the plurality of configuration objects based on the transaction request and the financial agreement record, one or more processing directive sequences applicable to the transaction request; (d) constructing a computational pipeline by resolving each processing directive in the applicable sequences to a registered processor implementation selected based on a context associated with the financial agreement record; (e) executing the computational pipeline against data of the financial agreement record, wherein each processor implementation accumulates results into a shared processing context accessible to subsequently executed processors; and (f) selectively persisting or withholding state changes based on a mode indicator associated with the transaction request, wherein a non-destructive mode returns computed results without persisting state changes and a commit mode persists state changes to the data store.

20. The method of claim 19, wherein the plurality of configuration objects comprise at least two independent configuration object types, each type independently defining processing directive sequences, and wherein constructing the computational pipeline comprises composing directives from the at least two independent configuration object types using one of: concatenation merging, priority-weighted merging, override-based composition, or dependency-graph-based composition.

21. The method of claim 19, wherein resolving each processing directive to a registered processor implementation comprises evaluating one or more scope dimensions associated with the financial agreement record against scope identifiers associated with candidate processor implementations, selecting a processor implementation whose scope identifiers most specifically match the scope dimensions of the financial agreement record, and selecting a less-specific or unscoped processor implementation as a fallback when no specific-scope match exists.

22. A computer-implemented method for projecting financial liability cash flows by reusing production transaction processor implementations in a non-destructive preview mode across a multi-dimensional parameter space of agreement records, economic scenarios, and time steps, comprising: (a) storing, in a data store, a set of economic scenarios comprising correlated paths for a plurality of economic factors over a projection horizon; (b) storing, in the data store, a set of actuarial assumptions organized in a hierarchical structure comprising carrier-level assumptions, product-family-level assumptions inheriting from the carrier level, product-version-level assumptions inheriting from the product-family level, and agreement-instance-level assumptions inheriting from the product-version level, wherein each assumption record specifies an assumption category, an assumption type, and a resolution level; (c) for each insurance agreement in a policy cohort and each economic scenario, resolving actuarial assumptions by traversing the hierarchical structure from the agreement-instance level upward and applying the most specific assumption at each category; (d) for each insurance agreement, each economic scenario, and each time step in the projection horizon: resolving economic factor values for the time step from the scenario; computing dynamic decrement rates by executing behavior model processor implementations through a product-scoped processor registry; projecting segment-level performance by executing indexed crediting processor implementations through the product-scoped processor registry using index returns from the economic scenario; executing a transaction calculation in a preview mode through the product-scoped processor registry using the same processor implementations used for production transaction processing, without persisting state changes; and storing the resulting projected cash flows; (e) wherein the processor implementations executed in step (d) are the identical processor implementations registered for production transaction processing, such that projected calculations produce results substantially corresponding to production calculations by virtue of execution through the same processor resolution and execution pathway under equivalent inputs, without requiring a separately maintained actuarial projection model.

23. The method of claim 22, further comprising generating a structured data export from the projected cash flows in a format consumable by an external actuarial system, the export comprising at least one of: a seriatim policy data extract containing policy-level financial positions and configuration parameters; a cash flow extract containing the projected cash flows from step (d); and a combined extract containing both seriatim data and projected cash flows; wherein the external actuarial system consumes the export to perform reserve aggregation using the policy administration system's projected cash flows, eliminating projection-level model-to-administration reconciliation.

24. The method of claim 22, further comprising computing a stochastic reserve by: for each insurance agreement and each scenario, computing a Greatest Present Value of Accumulated Deficiency (GPVAD) from the projected cash flows; sorting the GPVAD values across scenarios in descending order; and computing a Conditional Tail Expectation at a configurable confidence level as the average of the worst scenarios.

25. The method of claim 24, further comprising computing a deterministic reserve using prescribed economic scenarios and static actuarial assumptions, computing a net premium reserve floor using issue-date locked-in assumptions, and determining a final reserve as a maximum of the stochastic reserve, the deterministic reserve, and the net premium reserve floor.

26. The method of claim 22, wherein the use of identical processor implementations for both production transactions and projection calculations produces results that substantially correspond between production and projection contexts by virtue of execution through the same registry resolution mechanism and execution pathway under equivalent inputs, and wherein the non-destructive execution context that prevents modification of production agreement records is achieved by one of: halting the multi-phase processing pipeline before a commitment phase; executing within a database transaction that is subsequently rolled back; executing against an in-memory snapshot of agreement state; or directing persistence operations to a projection-specific data store separate from the production data store.

27. The method of claim 26, wherein the non-destructive execution context is achieved by one of: halting a multi-phase processing pipeline before a commitment phase; executing within a database transaction that is subsequently rolled back; executing against an in-memory snapshot of agreement state; or directing persistence operations to a projection-specific data store separate from the production data store.

28. A computer-implemented system for projecting financial liability cash flows by reusing production transaction processor implementations in a non-destructive preview mode, comprising: an economic scenario store maintained in one or more data stores, the scenario store configured to receive, validate, and serve sets of correlated economic factor paths over a projection horizon; a hierarchical assumption store maintained in the one or more data stores, the assumption store organizing actuarial assumptions in a hierarchical structure comprising carrier-level, product-family-level, product-version-level, and agreement-instance-level assumptions, with a resolution mechanism that traverses from the agreement-instance level upward and applies the most specific assumption at each category; a projection orchestrator executing on one or more processors, the projection orchestrator configured to: for each insurance agreement in a policy cohort and each economic scenario, resolve actuarial assumptions using the hierarchical assumption store; for each time step in the projection horizon, execute transaction calculations through a product-scoped processor registry in a preview mode that returns calculated financial impacts without persisting state changes, using the identical processor implementations registered for production transaction processing; and store resulting projected cash flows; and a cash flow store configured to persist the projected cash flows with configurable storage strategies; wherein the use of identical production processor implementations for projection calculations, executed through the same product-scoped processor registry and resolution mechanism, produces projection results that correspond to production results without requiring a separately maintained actuarial projection model.

29. A computer-implemented method for managing versioned rate level records with atomic status transitions within a multi-tenant data store architecture, comprising: (a) receiving, by a processing system, rate calculation outputs from a pricing calculation system; (b) creating a rate level record associated with a product identifier and an effective date type indicator, the effective date type indicator distinguishing between a new business rate applicable to newly issued agreements and a renewal rate applicable to existing agreements; (c) storing the rate level record in a pending status in a tenant-specific data store; (d) upon receiving an approval indication, atomically: transitioning the rate level record from the pending status to an active status, and transitioning any existing rate level record having the active status for the same product identifier and the same effective date type indicator to a superseded status; and (e) making the rate level record having the active status available to agreement transaction processing, whereby subsequent premium calculations for insurance agreements of the associated product use rate parameters from the rate level record having the active status.

30. The method of claim 29, wherein active rate level records for the new business rate track and active rate level records for the renewal rate track are maintained independently for the same product, such that new business agreements and renewal agreements reference different rate level records for the same product.

31. The method of claim 29, further comprising maintaining a history of rate level status transitions including: an identity of an approver for each transition to the active status, an approval timestamp, and an identifier of a rate level record that was transitioned to the superseded status, enabling regulatory audit of rate changes.

32. The method of claim 29, wherein the rate calculation outputs received in step (a) comprise rate adjustment recommendations transmitted from an AI-orchestrated asset-liability management and hedging engine through a pricing integration layer, the pricing integration layer transforming hedge cost metrics, reserve projections, and capital buffer calculations into the rate calculation outputs using configurable calibration rules, thereby establishing a closed-loop feedback path from hedging decisions through the rate publication pipeline to agreement transaction processing.

33. A computer-implemented system for coordinating distributed computational agents through standardized communication protocols to generate portfolio optimization outputs for financial products, comprising: (a) an orchestration engine executing on one or more processors, the orchestration engine managing task scheduling, dependency resolution, and output aggregation across a plurality of specialized computational agents; (b) the plurality of specialized computational agents comprising: data agents configured to collect and validate market data and insurance policy information; analysis agents configured to generate economic scenarios using stochastic processes and to project insurance liabilities across the generated scenarios by invoking a projection orchestrator that executes transaction calculations through a product-scoped processor registry in a preview mode without persisting state changes; strategy agents configured to construct and optimize hedge portfolios using multi-objective optimization subject to capital, earnings, and collateral constraints; actuarial agents configured to manage actuarial assumptions within a hierarchical governance framework, compute reserves, and determine capital requirements; and action agents configured to execute hedging decisions and transmit rate adjustment recommendations to a rate publication system; (c) a standardized communication layer through which the specialized computational agents exchange structured messages according to predefined protocols; (d) a human-in-the-loop governance interface providing manual approval, compliance validation, assumption review, and override capabilities at configurable decision points within agent workflows; and (e) a multi-tenant infrastructure providing database-per-tenant isolation with dynamic connection pool routing, enabling multiple tenants to operate with independent data stores while sharing the orchestration engine and the specialized computational agents; wherein the orchestration engine dynamically coordinates the specialized computational agents to produce hedging strategy recommendations and pricing adjustments responsive to changing market conditions.

34. The system of claim 33, further comprising a programmatic data transformation layer that: receives hedge cost metrics, reserve projections, and regulatory capital buffer calculations from the asset-liability management and hedging framework; transforms the received metrics into tenant-specific rate adjustment recommendations using configurable rate calibration rules that factor collateral utilization, risk-based capital constraints, and competitive benchmark data; transmits the rate adjustment recommendations through a programmatic publication mechanism to a rate publication pipeline; applies tenant-specific regulatory and business constraints to each rate adjustment recommendation; and continuously or at configurable intervals updates the rate adjustment recommendations as market conditions change.

35. The system of claim 33, further comprising a non-destructive evaluation environment that employs dual-mode transaction processing to assess computational strategy outputs prior to production deployment by: submitting transaction requests in a preview mode to a configurable transaction processing engine that executes a validation phase and a calculation phase of a multi-phase processing pipeline without executing a commitment phase; aggregating calculated results from the preview-mode transactions across a plurality of insurance agreements to produce portfolio-level impact projections; and presenting the portfolio-level impact projections including projected reserve impacts, capital requirement changes, and earnings effects for evaluation prior to deployment.

36. The system of claim 33, wherein each category of specialized computational agents operates within a defined scope of responsibility, and wherein the standardized communication layer implements predefined message exchange protocols that define the structure and semantics of messages exchanged between agents of different categories.

37. The system of claim 33, wherein the multi-tenant infrastructure comprises: a master database storing tenant definitions and API key records hashed using a cryptographic hash function; a plurality of tenant databases each providing isolated data storage for a single tenant; and a dynamic routing mechanism that maintains a connection pool for each tenant database and routes incoming requests to the appropriate tenant database based on the authenticated API key associated with the request.

38. The system of claim 33, wherein the analysis agents generate economic scenarios using a correlated multi-factor stochastic process comprising: geometric Brownian motion for equity index paths, mean-reverting processes for interest rate paths, and volatility-specific processes for implied volatility surfaces, with correlations between factors maintained through a Cholesky decomposition of an empirical correlation matrix.

39. The system of claim 33, wherein the strategy agents employ a multi-objective optimization algorithm comprising a progressive refinement approach that: relaxes integer constraints on derivative contract quantities and solves a continuous optimization problem; gradually tightens the integer constraints through successive iterations; and applies full integer constraints in a final iteration to produce near-optimal derivative portfolio allocations.

40. The system of claim 33, wherein the strategy agents employ a multi-objective optimization with a weighted objective function comprising: (1-α) multiplied by a variance of net positions across scenarios plus α multiplied by a mean shortfall across scenarios, where α is a configurable risk aversion parameter, subject to constraints including maximum cost, minimum coverage ratio, maximum collateral utilization per stress scenario, and maximum number of options per expiry date.

41. The system of claim 33, wherein the analysis agents include a dynamic policyholder behavior model that calculates lapse rates responsive to economic conditions with: asymmetric interest rate sensitivity wherein lapse rate increases more strongly when market rates exceed crediting rates than lapse rate decreases when crediting rates exceed market rates; an in-the-moneyness factor that reduces projected lapses when embedded guarantee values exceed account values; and credibility-weighted blending with company-specific experience data.

42. The system of claim 34, wherein the programmatic publication mechanism implements: business rule enforcement validating that rate adjustments fall within configured boundaries; compliance threshold checking against regulatory rate filing requirements; and audit trail generation recording the originating hedge metrics, the calibration rules applied, and the approval decision for each published rate adjustment.

43. The system of claim 34, wherein the pricing integration layer includes a human-in-the-loop approval mechanism applying configurable materiality thresholds, wherein rate adjustments below a configured threshold are published automatically and rate adjustments exceeding the threshold require manual sign-off through a governance interface before transmission to the rate publication pipeline.

44. The system of claim 33, wherein the multi-tenant infrastructure further supports periodic batch operations executed across the plurality of tenant databases using the dynamic connection pool routing, comprising: iterating over active tenants; establishing, for each tenant, a tenant-specific execution context using the dynamic connection pool routing; and executing one or more scheduled batch jobs within each tenant's isolated data store, wherein the batch jobs include at least one of: interest crediting to active agreement account values, renewal processing at term expiration, lapse processing for agreements past a grace period, annuitization conversion of accumulation-phase agreements to payout-phase agreements, valuation snapshot capture, and valuation projection execution; and wherein each batch job utilizes a configurable transaction processing engine that dynamically constructs and executes computational pipelines from data-store-resident configuration objects for individual transaction processing within the tenant's isolated data store.

45. The system of claim 35, wherein the simulation environment supports scenario-based stress testing by submitting preview-mode transactions under multiple economic stress scenarios and comparing portfolio-level impact projections across the scenarios.

46. A computer-implemented method for generating optimized derivative portfolio allocations using multi-objective constrained optimization with preview-mode liability projections, comprising: (a) receiving, by a processing system, real-time liability data and market data; (b) generating, by one or more analysis agents coordinated by an orchestration engine, a plurality of economic scenarios using correlated stochastic processes; (c) projecting insurance liabilities across the plurality of economic scenarios by executing transaction calculations through a product-scoped processor registry in a preview mode that returns calculated financial impacts without persisting state changes; (d) constructing, by one or more strategy agents, candidate hedge portfolios using a multi-objective optimization engine subject to capital constraints, earnings volatility constraints, and collateral constraints, wherein the multi-objective optimization engine employs a weighted combination of variance minimization and expected shortfall reduction with a configurable risk aversion parameter; and (e) outputting hedge strategy recommendations with attribution analysis and regulatory impact assessments.

47. A computer-implemented method for transforming computational optimization outputs into versioned rate level records through a multi-stage pipeline with governance gates, comprising: (a) ingesting, by a data orchestration service, hedge results and reserve projections from a distributed asset-liability management engine; (b) computing tenant-specific rate adjustments by applying configurable calibration rules that factor collateral utilization, risk-based capital constraints, and benchmark data; (c) presenting the computed rate adjustments for review through a human-in-the-loop interface, wherein adjustments exceeding a configurable materiality threshold require manual approval; (d) upon approval, transmitting approved rate adjustments through a programmatic publication mechanism to a rate publication pipeline; (e) creating versioned rate level records in the rate publication pipeline with full audit trail attribution; and (f) making the approved rates available to a configurable agreement lifecycle management system for use in subsequent transaction processing.

48. The method of claim 47, further comprising applying rate impact attribution for each update cycle, decomposing the rate adjustment into components attributable to changes in hedge costs, reserve projections, capital requirements, and competitive positioning.

49. A computer-implemented system comprising a unified data model and inter-component communication layer implementing closed-loop computational feedback through which: liability projection components receive insurance agreement data from a configurable lifecycle management system that stores agreement state in data-store-resident configuration objects and processes transactions through a three-phase execution engine, and generate liability cash flow projections by executing the same product-scoped processor implementations registered in a processor registry for production transaction processing, in a preview mode that halts execution after a calculation phase without persisting state changes; hedge optimization components receive the liability cash flow projections and generate optimized hedge strategies using multi-objective constrained optimization; and pricing components receive hedge cost metrics from the hedge optimization components and transmit rate adjustment recommendations through a programmatic publication mechanism to a rate publication pipeline within the configurable lifecycle management system, the rate publication pipeline creating versioned rate level records that are consumed by the three-phase execution engine during subsequent production transaction processing; thereby establishing a closed-loop feedback path from production agreement data through projection, optimization, and rate publication back to production transaction processing.
